(19) United States
(12) Patent Application Publication
(10) Pub. No.: US 2026/0327089 A1
(43) Pub. Date: Oct. 22, 2026

(54) METHOD OF FORMING TWO-DIMENSIONAL MATERIAL

(71) Applicant: National University of Singapore, Singapore (SG)

(72) Inventors: Haobo LI, Singapore (SG); Edward Kurniawan NALAND, Singapore (SG); Muhammed Juvaid MANGATTUCHALI, Singapore (SG); Silvija GRADECAK-GARAJ, Singapore (SG)

(21) Appl. No.: 19/181,797

(22) Filed: Apr. 17, 2025

(30) Foreign Application Priority Data
Apr. 16, 2025 (SG) 10202500996Y

(51) Int. Cl. C01G 39/06

(52) U.S. Cl. CPC C01G 39/06; C01P 2002/82; C01P 2004/02; C01P 2004/03; C01P 2004/04; C01P 2004/20; C01P 2006/40

(57) ABSTRACT

Various embodiments may relate to a method of forming or growing a two-dimensional material. The method may include introducing charges to a dielectric layer or substrate such that a bond angle between adjoining bonds of atoms included in the dielectric layer or substrate is changed. The method may also include providing one or more precursors to form or grow the two-dimensional material on the dielectric layer or substrate.

### CROSS-REFERENCE TO RELATED APPLICATION

This claims the benefit of priority of Singapore patent application No. 10202500996Y filed Apr. 16, 2025, the contents of which are hereby incorporated by reference in its entirety for all purposes.

### TECHNICAL FIELD

Various embodiments of this disclosure may relate to a method of forming a two-dimensional (2D) material.

### BACKGROUND

Modern society relies heavily on computing performance scaling, driven by Moore's law and semiconductor miniaturization. However, traditional top-down lithography is reaching its limits due to atomic-scale transistors and rising costs. A strategy for precise material deposition at pre-defined locations on various substrates is needed to overcome these limitations and enable new integration schemes. Conventional patterning methods for electronic and optical devices involve complex, costly processes that can cause misalignments and material damage, especially for small-scale or two-dimensional (2D) material applications. While bottom-up approaches have been proposed, they still depend on resist-protected surfaces.

### SUMMARY

Various embodiments may relate to a method of forming or growing a two-dimensional material. The method may include introducing charges to a dielectric layer or substrate such that a bond angle between adjoining bonds of atoms comprised in the dielectric layer or substrate is changed. The method may also include providing one or more precursors to form or grow the two-dimensional material on the dielectric layer or substrate.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows a general illustration of a method of forming or growing a two-dimensional (2D) material according to various embodiments.

FIG. 2A shows a schematic illustrating growth of molybdenum disulfide (MoS₂) using an electron beam-guided chemical vapor deposition (CVD) process according to various embodiments.

FIG. 2B shows (left) an optical microscope image captured from a 2×2 patterned array on a silicon oxide (SiO₂) surface according to various embodiments; and (right) an atomic force microscopy (AFM) topography image of the lower left boundary region on the 1 cycle pattern according to various embodiments.

FIG. 2C shows (i) the atomic force microscopy (AFM) topography image of the lower left boundary region as shown in FIG. 2B (right) according to various embodiments; (ii) a plot of height (in nanometers or nm) as a function of lateral distance (in micrometers or μm) illustrating the line topography profile across the left white dashed line in (i) according to various embodiments; and (iii) a plot of height (in nanometers or nm) as a function of lateral distance (in micrometers or μm) illustrating the line topography profile across the right white dashed line in (i) according to various embodiments.

FIG. 2D shows a plot of intensity (×10⁴ counts) as a function of Raman shift (per centimeter or cm⁻¹) illustrating the Raman spectrum of molybdenum disulfide (MoS₂) in the irradiated region according to various embodiments.

FIG. 2E shows a molybdenum disulfide (MoS₂) Raman E_{2g} intensity mapping pattern with a customized irradiated areas having an irregular text shape after chemical vapor deposition growth according to various embodiments.

FIG. 2F shows (left) a scanning electron microscopy (SEM) in-lens image after irradiation according to various embodiments; and (right) an optical microscopy image of the molybdenum disulfide (MoS₂) formed using chemical vapor deposition (CVD) according to various embodiments.

FIG. 3A shows the scanning electron microscopy (SEM) images of patterns at locations with different distances from the molybdenum (Mo) precursor according to various embodiments.

FIG. 3B shows the magnified scanning electron microscopy (SEM) image with a distance of 17 mm from the molybdenum (Mo) precursor according to various embodiments.

FIG. 3C shows the magnified scanning electron microscopy (SEM) image with a distance of 20 mm from the molybdenum (Mo) precursor according to various embodiments.

FIG. 3D shows the magnified scanning electron microscopy (SEM) image with a distance of 23 mm from the molybdenum (Mo) precursor according to various embodiments.

FIG. 3E shows the magnified scanning electron microscopy (SEM) image with a distance of 26 mm from the molybdenum (Mo) precursor according to various embodiments.

FIG. 3F shows the scanning electron microscopy (SEM) images of patterns with different numbers of electron irradiation scan cycles according to various embodiments. The scale bar represents 3 μm.

FIG. 3G shows the whole field image of the four patterns with different numbers of electron irradiation scan cycles according to various embodiments.

FIG. 3H shows a plot of selectivity S as a function of distance from the molybdenum (Mo) precursor (in millimeters or mm) illustrating selectivity variation as a function of distance between the patterns and the Mo precursor according to various embodiments.

FIG. 3I shows a plot of selectivity S as a function of the number of scan cycles on the irradiated area according to various embodiments.

FIG. 3J shows (left) an atomic force microscopy (AFM) topography image of a pattern with high selectivity according to various embodiments; and (right) a magnified atomic force microscopy (AFM) topography image of the region in the left image as indicated by the dashed lines according to various embodiments.

FIG. 3K shows a Raman molybdenum disulfide (MoS₂) E_{2g} peak intensity mapping of the patterned area as shown in the left image of FIG. 3J according to various embodiments.

FIG. 3L shows a scanning electron microscopy (SEM) image of a 20×20 μm² 5 keV irradiated area (lower left corner) after growth according to various embodiments.

FIG. 4A shows (left) an atomic force microscopy (AFM) topography image of the negatively patterned area of 3×4 μm² according to various embodiments; and (right) a magnified topography image of the edge region indicated by the black box in the left image according to various embodiments.

FIG. 4B shows a plot of intensity (×10³ counts) as a function of Raman shift (per centimeter or cm⁻¹) illustrating the Raman spectrum extracted from the high dose irradiated area according to various embodiments, indicating carbon deposition.

FIG. 4C shows a plot of intensity (×10³ counts) as a function of Raman shift (per centimeter or cm⁻¹) illustrating the Raman spectrum extracted from the non-irradiated area according to various embodiments, indicating molybdenum disulfide (MoS₂) deposition.

FIG. 4D shows a Raman peak intensity mapping of carbon D and G bands after high-dose irradiation and chemical vapor deposition (CVD) growth around the region marked in FIG. 4A. according to various embodiments.

FIG. 4E shows a Raman peak intensity mapping of molybdenum disulfide (MoS₂) E_{2g} peak around the same region as indicated in FIG. 4D according to various embodiments.

FIG. 5A shows an optical microscopy image of the whole patterning area, including the 3×4 μm² patterns according to various embodiments.

FIG. 5B shows a schematic illustrating the pattern size and pitch of an array in which the same dose of 1 nC/μm² is applied to each pattern according to various embodiments.

FIG. 5C shows a plot of intensity (10× counts) as a function of Raman shift (per centimeter or cm⁻¹) illustrating the Raman spectra of chemical vapor deposition (CVD) preferential growth areas after irradiation in these areas in the Versa scanning electron microscopy (SEM) according to various embodiments.

FIG. 5D shows a Kelvin probe force microscopy (KPFM) mapping of the array according to various embodiments.

FIG. 5E shows an optical microscopy image of the array according to various embodiments.

FIG. 5F shows atomic force microscopy (AFM) topography images of each pattern from A to D as shown in FIG. 5B according to various embodiments.

FIG. 6A shows a Kelvin probe force microscopy (KPFM) mapping of the array after being irradiated with a dose of 0.08 nC/μm² according to various embodiments.

FIG. 6B shows a Kelvin probe force microscopy (KPFM) mapping of the array after being irradiated with a dose of 0.24 nC/μm² according to various embodiments.

FIG. 6C shows a Kelvin probe force microscopy (KPFM) mapping of the array after being irradiated with a dose of 1.0 nC/μm² according to various embodiments.

FIG. 6D shows a Kelvin probe force microscopy (KPFM) mapping of the array in which the top two patterns are irradiated with a dose of 0.24 nC/μm² and the bottom two patterns are irradiated with a dose of 1.0 nC/μm² according to various embodiments.

FIG. 6E shows an atomic force microscopy (AFM) topography image of the array after being irradiated with a dose of 0.08 nC/μm² according to various embodiments.

FIG. 6F shows an atomic force microscopy (AFM) topography image of the array after being irradiated with a dose of 0.24 nC/μm² according to various embodiments.

FIG. 6G shows an atomic force microscopy (AFM) topography image of the array after being irradiated with a dose of 1.0 nC/μm² according to various embodiments.

FIG. 6H shows an atomic force microscopy (AFM) topography image of the array in which the top two patterns are irradiated with a dose of 0.24 nC/μm² and the bottom two patterns are irradiated with a dose of 1.0 nC/μm² according to various embodiments.

FIG. 6I shows plots of height along the Z-axis (in nanometers or nm) as a function of lateral distances (in micrometers or μm) illustrating the line profiles of irradiated pattern areas extracted respectively from atomic force microscopy (AFM) images as shown in FIGS. 6E-G according to various embodiments.

FIG. 6J shows a plot of average height (in nanometers or nm) as a function of position illustrating depths of the patterns in positions A-D as shown in FIGS. 6E-H according to various embodiments.

FIG. 7A is a schematic illustrating a Monte Carlo stimulation on the trajectory of electrons of a 5 keV electron beam on a 300 nm thick silicon oxide (SiO₂) layer according to various embodiments.

FIG. 7B is a schematic illustrating a Monte Carlo stimulation on the trajectory of electrons of a 30 keV electron beam on a 300 nm thick silicon oxide (SiO₂) layer according to various embodiments.

FIG. 8A shows an atomic force microscopy (AFM) topography image of an as-irradiated silicon oxide (SiO₂) surface after a dose of 1 nC/μm² according to various embodiments.

FIG. 8B shows a Kelvin probe force microscopy (KPFM) surface potential mapping image of the as-irradiated silicon oxide (SiO₂) surface as shown in FIG. 8A after the dose of 1 nC/μm² according to various embodiments.

FIG. 8C shows a plot of contact potential difference CPD (in millivolts or mV) as a function of dose (in nano-Coulomb per square micrometer or nC/μm²) illustrating the variation of CPD with dose according to various embodiments.

FIG. 8D shows a Kelvin probe force microscopy (KPFM) surface potential mapping image of the irradiated area after 30 keV irradiation using a dose of 0.1 nC/μm² according to various embodiments.

FIG. 8E shows a Kelvin probe force microscopy (KPFM) surface potential mapping image of the irradiated area after 30 keV irradiation using a dose of 0.2 nC/μm² according to various embodiments.

FIG. 8F shows a Kelvin probe force microscopy (KPFM) surface potential mapping image of the irradiated area after 30 keV irradiation using a dose of 0.4 nC/μm² according to various embodiments.

FIG. 8G shows a Kelvin probe force microscopy (KPFM) surface potential mapping image of the irradiated area after 30 keV irradiation using a dose of 0.6 nC/μm² according to various embodiments.

FIG. 8H shows a Kelvin probe force microscopy (KPFM) surface potential mapping image of the irradiated area after 30 keV irradiation using a dose of 0.8 nC/μm² according to various embodiments.

FIG. 8I shows a Kelvin probe force microscopy (KPFM) surface potential mapping image of the irradiated area after 30 keV irradiation using a dose of 1.0 nC/μm² according to various embodiments.

FIG. 8J shows an optical microscopy image of the as-grown molybdenum disulfide (MoS₂) pattern according to various embodiments.

FIG. 8K shows an optical image of the irradiated area after 30 keV irradiation using a dose of 1.0 nC/μm² according to various embodiments.

FIG. 8L shows an optical image of the irradiated area after 30 keV irradiation using a dose of 0.8 nC/μm² according to various embodiments.

FIG. 8M shows an optical image of the irradiated area after 30 keV irradiation using a dose of 0.6 nC/μm² according to various embodiments.

FIG. 8N shows an optical image of the irradiated area after 30 keV irradiation using a dose of 0.4 nC/μm² according to various embodiments.

FIG. 8O shows an optical image of the irradiated area after 30 keV irradiation using a dose of 0.2 nC/μm² according to various embodiments.

FIG. 8P shows an optical image of the irradiated area after 30 keV irradiation using a dose of 0.1 nC/μm² according to various embodiments.

FIG. 8Q shows an atomic force microscopy (AFM) topography image of as-grown molybdenum disulfide (MoS₂) on silicon oxide (SiO₂) surfaces according to various embodiments.

FIG. 8R shows a zoomed-in image of the right edge of the irradiated area in FIG. 8Q according to various embodiments.

FIG. 8S shows a plot of density of nucleations (counts/square micrometer or cnts/μm²)/cover ratio (in percent or %) as a function of dose (in nano-Coulomb per square micrometer or nC/μm²) illustrating the variation of coverage and nucleation with does according to various embodiments.

FIG. 9A shows a plot in intensity (in millivolts or mV) as a function of wavenumber (per centimeter or cm⁻¹) illustrating the asymmetrical traverse optical (TO) bands of non-irradiated and irradiated amorphous silicon oxide (SiO₂) surface according to various embodiments.

FIG. 9B shows an intensity mapping illustrating the spatial contrast between the irradiated area and the non-irradiated area at 1035 cm⁻¹ according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance, e.g. within 10% of the specified value.

As used herein, the term “and/or” includes any and all combinations of one or more of the associated listed items.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

To address the issues mentioned above, a guided substrate treatment for selective growth may be necessary, modifying only specific areas without using resists.

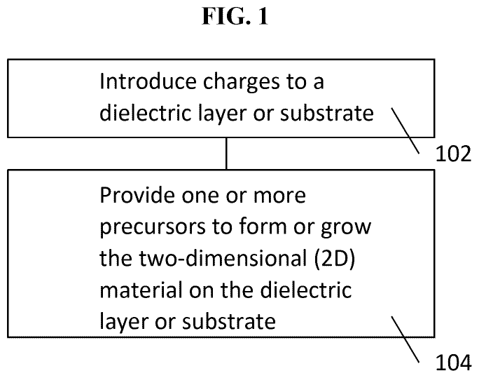

FIG. 1 shows a general illustration of a method of forming or growing a two-dimensional (2D) material according to various embodiments. The method may include, in 102, introducing charges to a dielectric layer or substrate such that a bond angle between adjoining bonds of atoms included in the dielectric layer or substrate is changed. The method may also include, in 104, providing one or more precursors to form or grow the two-dimensional (2D) material on the dielectric layer or substrate.

By directing or introducing charges to selected regions, spots or areas of the dielectric layer or substrate, selective growth of the 2D material on the selected regions, spots or areas of the dielectric layer or substrate may occur, thereby achieving a guided substrate treatment for selective growth.

In various embodiments, the dielectric layer or substrate may include silicon oxide (SiO₂), hydrogenated silicon-carbon (SiCH), fluorinated silicon oxide (SiOF), aluminum oxide (Al₂O₃), hafnium oxide (HfO₂) or zirconium oxide (ZrO₂). In one example, the dielectric layer or substrate may be a silicon oxide layer or substrate, and charges introduced to the dielectric layer or substrate may cause a change in the bond angle of the Si—O—Si.

The charges may be introduced to the dielectric layer or substrate using any suitable means, using an irradiation process such as electron beam (e-beam) irradiation, ion beam irradiation or laser beam irradiation. Electron beam irradiation may enable a mask-free customized irregular pattern shape formation, e.g., during the chemical vapor deposition (CVD), thereby providing more freedom to pattern shape design and growth.

The change in the bond angle may lead to preferential growth of the two-dimensional (2D) material. In various embodiments, e.g., when the chamber is free from contaminants and/or when the dose used is fairly low, irradiation of a particular region, spot or area of the dielectric layer or substrate, e.g., using the electron beam or ion beam, may lead to preferential growth of the two-dimensional material in that particular region/spot/area.

Generally speaking, the change in the bond angle may lead to a change in a number of free bonds present in the dielectric layer or substrate. A change in the number of free bonds present in a region/spot of the dielectric layer or substrate may lead to preferential growth of the two-dimensional (2D) material in that particular region/spot.

In various embodiments, the two-dimensional (2D) material may be a transition metal dichalcogenide (TMDC) material.

In various embodiments, the transition metal dichalcogenide (TMDC) material may be any material having the formula MX₂, where M represents a transition metal as molybdenum (Mo), tungsten (W) or vanadium (V), while X presents chalcogen atoms such as sulfur (S), selenium (Se) or tellurium (Te). Examples may include molybdenum disulfide (MoS₂), molybdenum diselenide (MoSe₂), tungsten disulfide (WS₂) or tungsten diselenide (WS₂).

In one example, the transitional metal dichalcogenide material may be MoS₂. Molybdenum oxide (MoO₃) may be positioned at a predetermined distance from the dielectric layer or substrate. Sulfur is carried by an inert gas (e.g., nitrogen gas, helium gas or argon gas) to react with molybdenum oxide (MoO₃) to form molybdenum disulfide (MoS₂) on the dielectric layer or substrate. In various embodiments, the predetermined distance may be at least 20 mm. When the predetermined distance is 20 mm or above, the selectivity (S), i.e., ability of a growth process to preferentially affect one area over another area, may increase with distance. In various embodiments, the selectivity may also increase with dose, which may in turn be correlated to the number of scan cycles.

The two-dimensional material (2D) material (e.g., MoS₂) may be grown using chemical vapor deposition (CVD). For MoS₂, the MoS₂ may be grown using a temperature selected from a range from 400° C. to 650° C., e.g., 400° C. to 600° C. or 600° C. to 650° C., which may be lower than the standard 700° C. for growth of MoS₂ using CVD. The lower temperature may suppress growth of MoS₂ in the non-irradiated regions/spots/areas, while allowing for preferential growth of MoS₂ in the irradiated regions/spots/areas. Generally speaking, the temperature used for growth of the 2D material or the TMDC material via the method as described herein may be lower than the corresponding standard temperature used for conventional CVD of the 2D material or the TMDC material (without irradiation).

In various embodiments, the method may further include forming an amorphous carbon layer on the dielectric layer or substrate. The amorphous carbon layer may be formed due to contaminants, e.g., carbon contaminants present in the chamber (e.g., the CVD chamber). In other words, the contaminants may be present in the chamber. At a sufficiently high dose (i.e., a dose beyond a predetermined threshold), the amorphous carbon layer may be formed on the dielectric layer or substrate. The amorphous carbon layer may serve as a blocking layer. In other words, growth of the 2D material or the TMDC material on the blocking layer (i.e., the amorphous carbon layer) may be prevented or reduced, while surroundings of the irradiated area exposed to a lower dose (i.e., regions/spots/areas of the dielectric layer or substrate not covered by the blocking layer) may experience growth of the 2D material or the TMDC material. The contaminants may be deliberately introduced in the chamber, or may be present by not including a cryotrap in the chamber to remove or reduce the contaminants. Increasing the irradiation dose (e.g., by reducing irradiation area and/or increasing irradiation time) may help to form the amorphous carbon layer from the contaminants.

Assuming that the amorphous carbon layer is not formed (e.g., by including a cryotrap in the chamber to reduce the contaminants) and assuming the dose is kept constant, less surface damage of the dielectric layer or substrate may occur with increasing incident beam energy of the electron beam, or ion beam. On the other hand, a laser beam with increasing photon energy (i.e., shorter wavelengths) may have shallower penetration depth (i.e. penetration localized to a shallower volume of material), thereby causing more energy deposited on surface, which may lead to more surface damage. In other words, for the same dose, lasers with higher photon energies may cause more surface damage compared to lasers with lower photon energies. Surface potential contrast between the irradiated region and the non-irradiated region may become more pronounced.

An energy of the irradiation process (i.e., for electron beam or ion beam) below a predetermined threshold may form or create etched features on the dielectric layer or substrate. For instance, it has been demonstrated herein that an energy of electron beam irradiation of 5 keV at a certain dose level may create etched features in the dielectric layer or substrate. The edge steps (i.e., stepped features in which there is a change in profile height) of the etched features may show preferential growth of the two-dimensional material.

Conversely, the energy of the irradiation process (i.e., for electron beam or ion beam) equal to or exceeding the predetermined threshold may not create etched features on the dielectric layer or substrate. For instance, it has been demonstrated herein that an energy of electron beam irradiation of 30 keV at the certain dose level may not create etched features in the dielectric layer or substrate. In other words, at a predetermined dose level, when the energy of the irradiation beam (e.g., electron beam or ion beam) is below a certain threshold, etched features may be formed on the dielectric layer or substrate. In contrast, when the energy of the irradiation beam is equal to or more than the certain threshold, etched features may not be formed on the dielectric layer or substrate. For a laser beam, at a predetermined dose level, when the energy of the irradiation beam is equal to or exceeds a certain threshold, etched features may be formed or created on the dielectric layer or substrate. Conversely, when the energy of the irradiation beam (i.e., laser beam) is below the certain threshold, etched features may not be formed or created on the dielectric layer or substrate.

In various embodiments, the contact potential difference (CPD) value between an irradiated region/spot and a non-irradiated region/spot may decrease (i.e. become more negative) with electron dose, while a density of nucleation/flake coverage may increase with electron dose. In other words, the decreasing trend of the negative CPD value with increasing dose may be inversely correlated with the increasing trends of nucleation density/coverage ratio (with increasing dose). Generally speaking, growth of the two-dimensional material may increase with a number of charges trapped in the dielectric layer or substrate.

Various embodiments may relate to a two-dimensional material or a transition metal dichalcogenide material formed by a method as described herein. Various embodiments may relate to a structure including a dielectric layer or substrate, and a 2D material (e.g., TMDC material) on the dielectric layer or substrate.

Various embodiments may enable selective growth of 2D materials, including transition metal dichalcogenides, on technologically relevant dielectric substrates. These substrates include low-k dielectrics (e.g., SiCH, SiO₂, SiOF) and high-k dielectrics (e.g., Al₂O₃, HfO₂, ZrO₂), though the applicability may not be limited to these materials. In various embodiments, the selectivity may be achieved by irradiation, e.g., electron beam irradiation, of the dielectric substrates, which chemically modifies the surface to facilitate the selective growth of 2D materials exclusively in irradiated regions. The resulting patterns can be utilized for lithography-free channel materials in front-end-of-line (FEOL) applications.

Various embodiments may allow for direct growth of 2D materials without transfer. The need for transfer processes may be eliminated, reducing complexity and potential contamination. Various embodiments may not require lithography for patterning, which may in turn help avoid challenges associated with photo/e-beam lithography, such as photoresist residues, defects from lift-off processes, film peeling issues, etching-related damage, exposure to high-energy radiation, pattern distortion, and other related problems. Various embodiments may also achieve resolution beyond industry standards. While state-of-the-art high numerical aperture (NA) extreme ultraviolet (EUV) tools may achieve resolutions of ~8 nm, various embodiments may achieve sub-5 nm resolution, depending on the precision of the electron beam irradiation.

The selective growth of MoS₂ using electron beam irradiation in a chemical vapor deposition (CVD) system has been demonstrated herein. Alternative irradiation methods can include electron beams, lasers, or ions, depending on the specific application.

Various embodiments may have broad applicability in the semiconductor industry, e.g., lithography-free channel materials (suitable for short-channel applications in future sub-nm nodes in FEOL), active materials (such as memory devices and memristors for FEOL applications), liners/barriers for back-end-of-line (BEOL, selective growth on low-k or high k-dielectric layers, avoiding growth on metals), sensors (direct fabrication of selective sensing regions on substrates) and optoelectronics (controlled deposition of materials for photonic or quantum applications).

Various embodiments may significantly reduce the complexity of fabricating 2D materials patterns for commercial applications such as 2D materials-based devices, and 2D materials-based catalysts, which entails the multi-step photolithography process to fabricate desired pattern array and realize specific functionalities. According to Commercial Times published in Taiwan, Taiwan Semiconductor Manufacturing Company (TSMC) reportedly invests over USD 12.3 billion in EUV photolithography. The EUV scanner also consumes substantial amounts of electricity more than 1,000 kW each. Various embodiments may provide a technical pathway to bypass the complexity of photolithography process, and may save energy costs, making the fabrication of the 2D materials-based devices more eco-friendly and cost-effective.

Modern society depends on the rapid, predictable and affordable scaling of computing performance for virtually every aspect of our daily lives: consumer electronics, communication, trade, transportation, or national security. Over the past few decades, the driving force of this scaling has been the semiconductor device miniaturization, famously known as Moore's law. However, the top-down lithography—a conventional technological driver underpinning Moore's law for 50 years—is failing as silicon transistors reach the atomic scale and fabrication costs continue to rise globally. To avoid cost and performance limitations of traditional patterning methods, it may be critical to develop a fundamentally different strategy in which material is deposited at pre-defined locations, on arbitrary substrates, and with nanoscale precision. Such processes may not only simplify the existing manufacturing flows, but may also enable new integration schemes beyond silicon.

The fabrication of conventional electronic and optical devices may require patterning processes to define the desired circuits. The conventional top-down lithography-based patterning methods may require a polymer-based resist and a number of processing steps to realize the desired structure. Each of these steps may add to the process complexity and increase the process cost dramatically. For small device features of current technological interest, this multi-step patterning may result in misalignments when used for three-dimensional (3D) structures and multilayer 2D structures. Furthermore, the resolution of the lithographic methods as well as the resulting materials damage may render conventional approaches unusable at small scales or for emerging systems such as 2D materials. In the case of 2D materials, the lithography steps can damage the patterned material and the residual resist is detrimental to 2D devices, including the commonly used lift-off approach due to weak van der Waals interaction of 2D materials with substrates. To address this issue, several bottom-up approaches have been suggested, but these still rely on substrate surfaces protected by resists/masks. Therefore, it may be necessary to develop a guided substrate treatment for selective growth, which modifies only the designed area of the sample without any resist.

### Methods

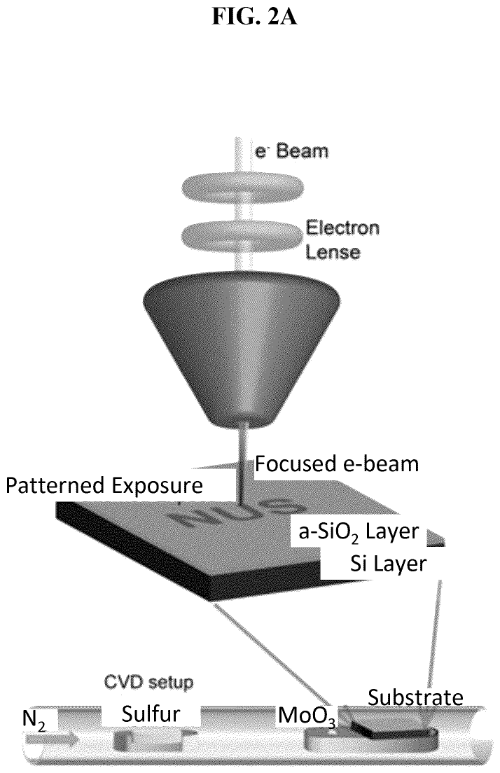

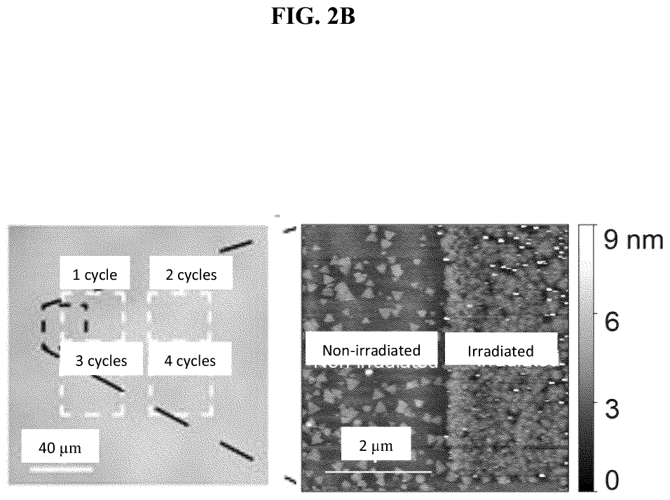

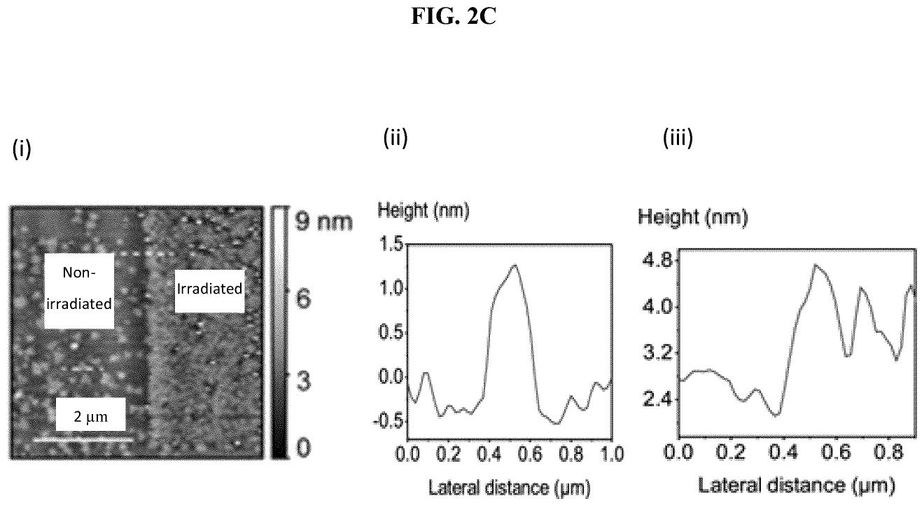

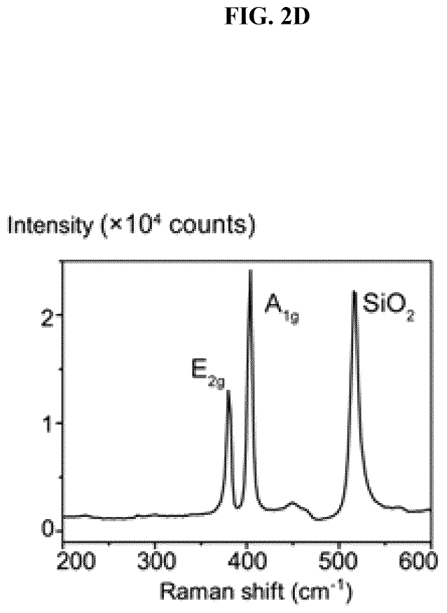

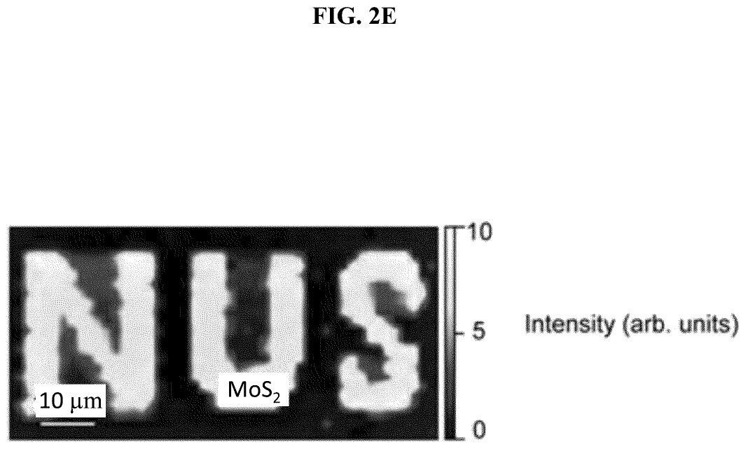

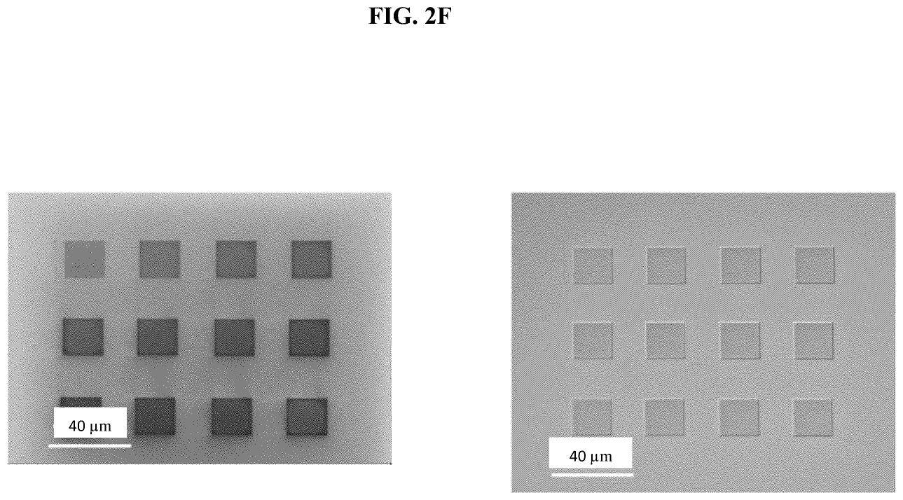

Charged particle beams, including electron and ion beams, can be directed by computer-controlled electromagnetic lenses, realizing the selective, spatially focused substrate engineering without introducing resist/mask to protect the substrate. FIG. 2A shows a schematic illustrating growth of molybdenum disulfide (MoS₂) using an electron beam-guided chemical vapor deposition (CVD) process according to various embodiments. The electrostatically-guided chemical vapor deposition (CVD) process may include electron beam exposure of the substrate in a scanning electron microscope (SEM) and subsequent chemical vapor deposition growth of MoS₂. This approach may have potential to significantly reduce process complexity and improved pattern fidelity for sub-5 nm patterning technology.

### Sample Preparation

A SiO₂/Si wafer (a 300 nm thick silicon oxide layer on an underlying Si base, purchased from Nanyang Equipment Pte. Ltd.) was cut into 2 cm×2 cm substrates and cleaned in acetone, isopropyl alcohol and deionized (DI) water before subsequent irradiation and growth. Electron beam irradiation was conducted in Sigma 300 SEM from Zeiss, and 3D Versa SEM from FEI. The selectivity optimization and negative selectivity were achieved by irradiation in Sigma 300 SEM. Irradiation investigation under 30 keV was conducted by 3D Versa SEM, which has a cleaner environment with cryotrap attachment. All irradiation works were conducted at a vacuum level of 10⁻⁶ mbar. After irradiation, the samples were vacuum packed for transportation to avoid unnecessary air exposure.

CVD growth of MoS₂ was conducted in a 2-inch tube with a single-zone heating furnace. The growth temperature was adjusted between 600° C. and 700° C. High purity sulfur powder (99.98%, Sigma-Aldrich) and MoO₃ powder (99.97%, Sigma-Aldrich) were used as precursors. ~50 mg sulfur powder was placed upstream of the nitrogen (N₂) gas flow, ~25 cm from the heating center. ~0.1 mg MoO₃ and substrate were placed at heating center, and next to each other with SiO₂ surface facing up. The growth time was tuned between 8 minutes (min) to 20 min in 18 standard cubic centimeter per minute (sccm) N₂ gas flow.

In FIG. 2B, the size of each rectangular irradiated area is 30×40 m². The electron beam reached the SiO₂/Si substrate surface with an energy of 5 keV, and the duration of the 4-cycles electron beam irradiation was 30 min. After irradiation, the CVD process was conducted on the substrate with 700° C. growth temperature for 8 min and 18 sccm N₂ gas flow rate to carry the sulfur precursor.

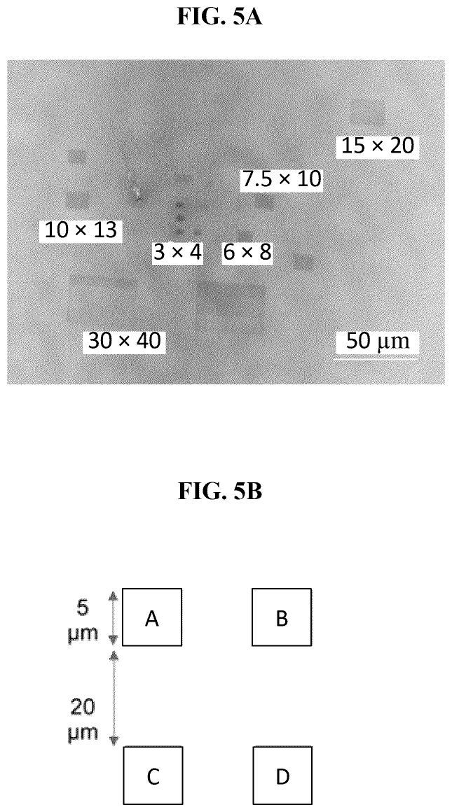

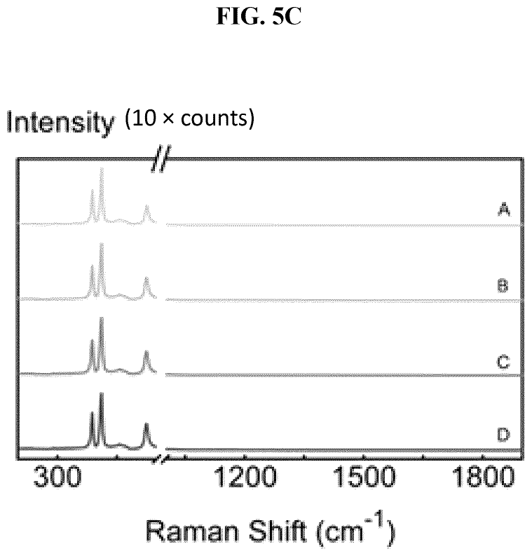

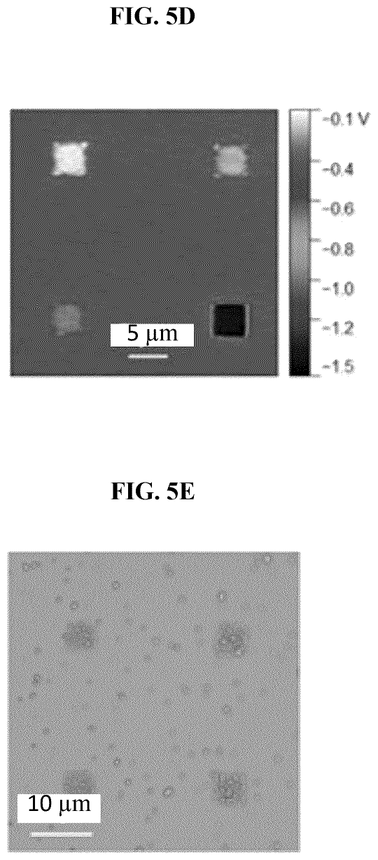

In FIG. 5A and FIG. 5C, the irradiation time is 162 seconds (s) for each pattern. In FIG. 5B, the irradiation time was varied as described later. The irradiation area and beam energy were maintained. In FIG. 5E, the size of the pattern is 6×8 μm² with irradiation time maintained at 162s. The CVD growth temperature was tuned between 600-650° C., and the growth time was kept between 15-20 minutes, with the N₂ gas flow rate maintained at 18 sccm.

### MoS₂ Characterization

Atomic force microscopy (AFM) measurements were performed in a NX10 AFM model from Park Systems. Kelvin probe force microscopy (KPFM) mode was used for characterization of as-irradiated samples, and topography images were acquired at the same time of surface potential mapping, as the signals were extracted from different channels. Typically, the set point for the Multi75-G tip (Budget Sensors) is ~7-13 nm. The basic AFM tapping mode with a typical AC160TS tip (Olympus) was used for characterization of as-deposited samples to acquire topographic images. Raman spectroscopy was conducted using a Horiba LabRAM spectrometer system with a laser wavelength of 488 nm in an ambient environment. The laser spatial resolution was around ~1 μm through a ×100 objective lens, and the laser power on the sample surface was estimated 0.28 mW.

### Results And Discussions

In the CVD process, MoS₂ can selectively grow on the electron irradiated areas. FIG. 2B shows (left) an optical microscope image captured from a 2×2 patterned array on a silicon oxide (SiO₂) surface according to various embodiments; and (right) an atomic force microscopy (AFM) topography image of the lower left boundary region on the 1 cycle pattern according to various embodiments. The white dash lines on the optical microscopy image indicate the boundary of the electron irradiated areas.

In the optical microscopy image, the electron-irradiated regions display pronounced growth of MoS₂, forming clearly defined patterns with distinct contrast against the sparse growth observed in non-irradiated regions. As proof of concept, the patterns are defined in rectangular shape. The size of each rectangle was 30×40 μm² and one patterning cycle is defined as a complete scan of electron beam on the rectangular region of the SiO₂/Si substrate indicated by the white dash line. The AFM topography image of the irradiated region shows it is covered by dense nucleation of MoS₂, in contrast to the sparse growth within the non-irradiated region.

FIG. 2C shows (i) the atomic force microscopy (AFM) topography image of the lower left boundary region as shown in FIG. 2B (right) according to various embodiments; (ii) a plot of height (in nanometers or nm) as a function of lateral distance (in micrometers or μm) illustrating the line topography profile across the left white dashed line in (i) according to various embodiments; and (iii) a plot of height (in nanometers or nm) as a function of lateral distance (in micrometers or μm) illustrating the line topography profile across the right white dashed line in (i) according to various embodiments. The AFM image of the boundary area shows that the irradiated region shows preferential growth compared to the non-irradiated region. In other words, the amount of MoS₂ formed in the irradiated region may be much more as compared to the amount of MoS₂ formed in the non-irradiated region.

FIG. 2D shows a plot of intensity (×10⁴ counts) as a function of Raman shift (per centimeter or cm⁻¹) illustrating the Raman spectrum of molybdenum disulfide (MoS₂) in the irradiated region according to various embodiments. The Raman spectroscopy may confirm that the as-grown material is MoS₂ through its characteristic in-plane E_{2g} and out-of-plane A_{1g} peaks at 380 cm⁻¹ and 403.5 cm⁻¹, respectively. The peak difference of 23.5 cm⁻¹ combined with the AFM height measurements is indicative of a three-layer MoS₂ film, given that the thickness of monolayer 2D MoS₂ is ~0.7 nm.

To demonstrate that the approach can be used for more complex patterned shapes, Raman peak intensity mapping of the MoS₂ E_{2g} peak is used as shown in FIG. 2E. FIG. 2E shows a molybdenum disulfide (MoS₂) Raman E_{2g} intensity mapping pattern with a customized irradiated areas having an irregular text shape after chemical vapor deposition growth according to various embodiments. MoS₂ is grown directly within the irradiated areas, thereby demonstrating the precision and flexibility in pattern geometry enabled by electron-irradiation-assisted CVD growth. Despite sparse MoS₂ growth observed outside of the irradiated areas, these preliminary growth results demonstrate MoS₂ CVD growth facilitated by electron irradiation on SiO₂/Si. Given the initial universal growth across the substrate, further optimization of the irradiation and growth parameters has been undertaken. These may be crucial to enhance selectivity, promoting dense MoS₂ nucleation within irradiated areas while effectively inhibiting growth in non-irradiated regions.

For the patterned growth assisted by electron irradiation, the overall growth on substrate is controlled by CVD conditions, and growth promotion within the irradiated area is dominated by electron irradiation parameters. To fine-tune the balance between overall substrate growth and targeted growth within irradiated areas, the CVD process temperature is adjusted from the standard 700° C. to a lower range of 600-650° C. This modification aimed to suppress non-targeted growth in the non-irradiated areas while preserving the conditions favorable for targeted growth.

FIG. 2F shows (left) a scanning electron microscopy (SEM) in-lens image after irradiation according to various embodiments; and (right) an optical microscopy image of the molybdenum disulfide (MoS₂) formed using chemical vapor deposition (CVD) according to various embodiments. The growth conditions used to form the MoS₂ as shown in the right image in FIG. 2E is 600-650° C. with 18 sccm N₂ flow for 15 minutes. A SiO₂/Si substrate is used.

The position of precursors in the CVD setup may be essential to the reaction of 2D-TMDs synthesis, especially the position of sulfur precursor. In the CVD setup shown in FIG. 2A, the Mo precursor (i.e., MoO₃) may be strategically positioned adjacent to the substrate, ensuring the MoO₃ concentration decreases along the gas flow direction on the substrate. This arrangement, with the SiO₂ surface facing upwards, enabled a detailed investigation into the effect of the Mo precursor concentration gradients on growth dynamics across the SiO₂/Si substrate. Moreover, the irradiation conditions were varied to investigate the promoted growth in irradiated areas. To quantify the effectiveness of the approach in achieving area-selective growth, the growth selectivity (S) may be selected to delineate the distinct growth behaviors in irradiated versus non-irradiated areas, providing a measurable indicator of the method's precision and efficiency:

$$S = \frac{{θ}_{I} - {θ}_{NI}}{{θ}_{I} + {θ}_{NI}} \qquad ( 1 )$$

Here, θ_{I} represents the MoS₂ coverage in the irradiated area; while θ_{NI} represents the MoS₂ coverage in the non-irradiated area.

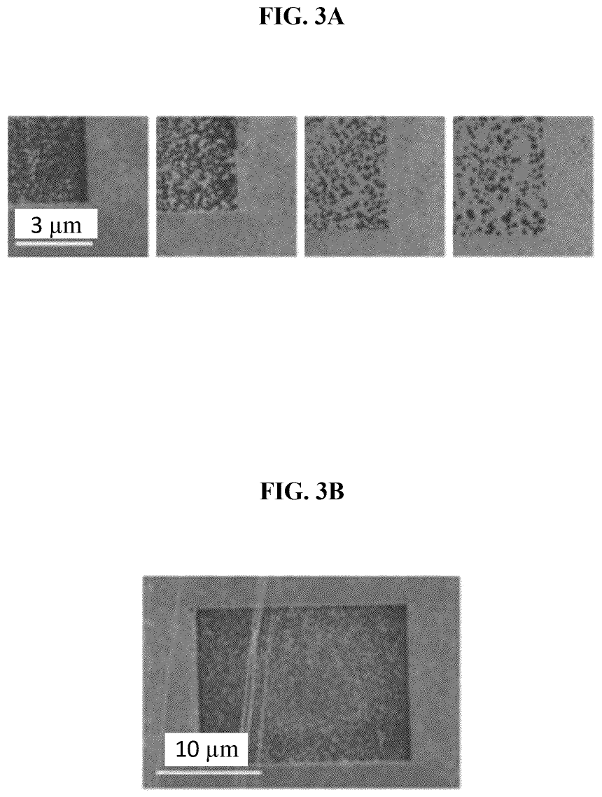

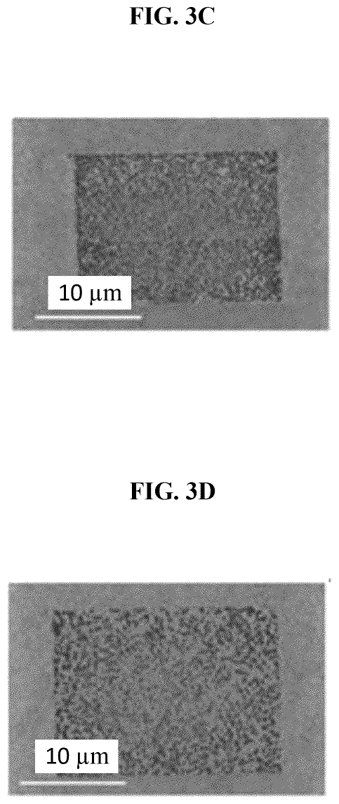

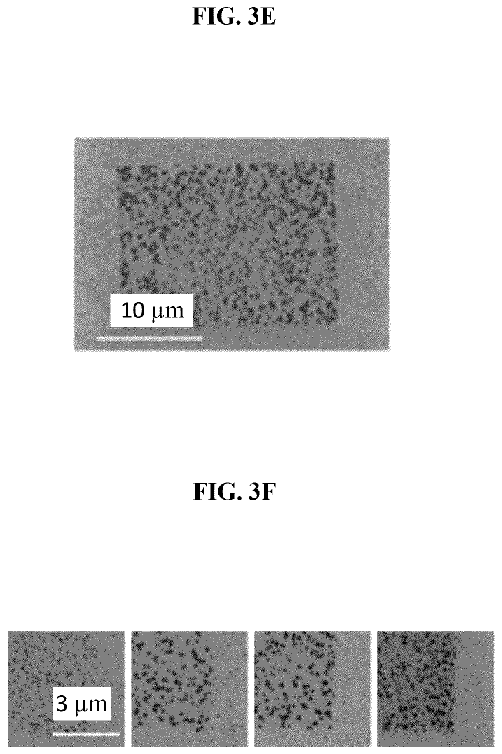

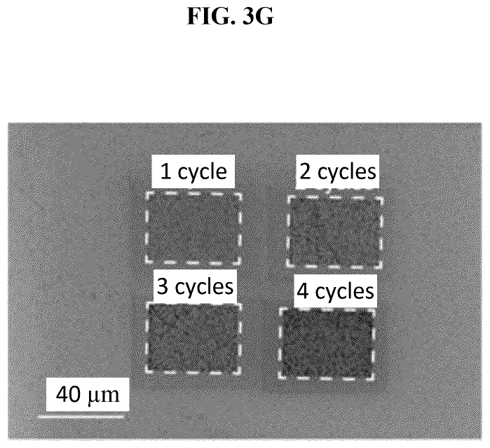

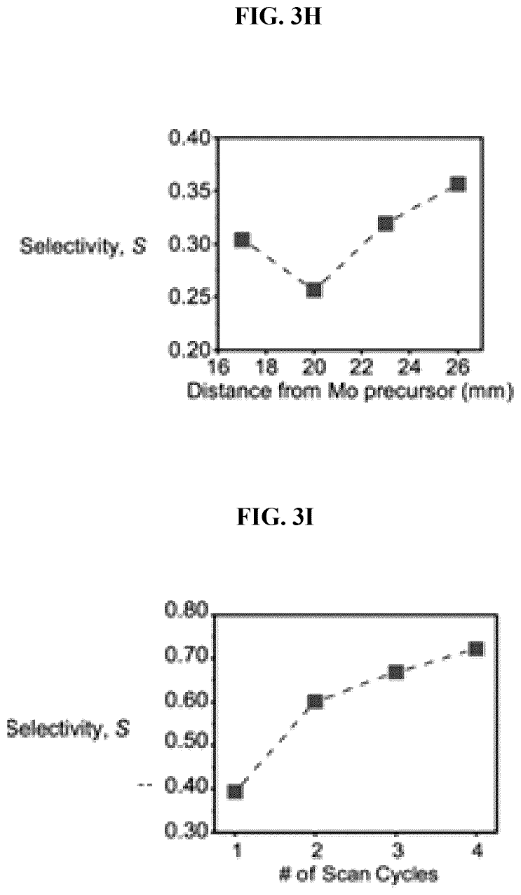

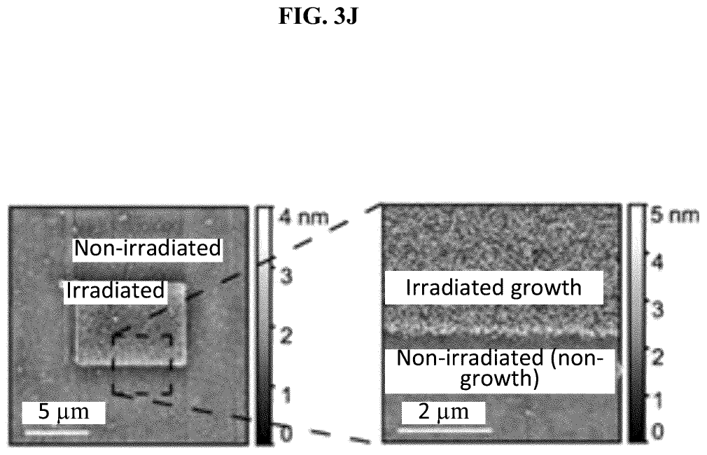

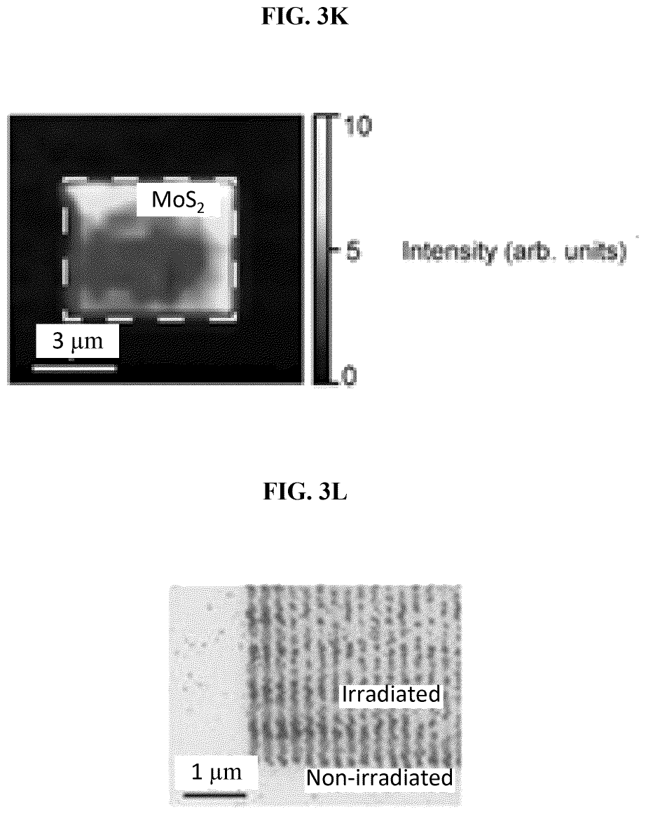

FIG. 3A shows the scanning electron microscopy (SEM) images of patterns at locations with different distances from the molybdenum (Mo) precursor according to various embodiments. The scale bar represents 3 μm. FIG. 3B shows the magnified scanning electron microscopy (SEM) image with a distance of 17 mm from the molybdenum (Mo) precursor according to various embodiments. FIG. 3C shows the magnified scanning electron microscopy (SEM) image with a distance of 20 mm from the molybdenum (Mo) precursor according to various embodiments. FIG. 3D shows the magnified scanning electron microscopy (SEM) image with a distance of 23 mm from the molybdenum (Mo) precursor according to various embodiments. FIG. 3E shows the magnified scanning electron microscopy (SEM) image with a distance of 26 mm from the molybdenum (Mo) precursor according to various embodiments.

FIG. 3F shows the scanning electron microscopy (SEM) images of patterns with different numbers of electron irradiation scan cycles according to various embodiments. The scale bar represents 3 μm. FIG. 3G shows the whole field image of the four patterns with different numbers of electron irradiation scan cycles according to various embodiments.

As shown in the images of FIGS. 3A-G, the experiments revealed a nuanced interplay between MoO₃ precursor concentration and electron irradiation in controlling the coverage and selectivity of MoS₂ film growth across the substrate. As discussed above, the increasing distance between each pattern and the MoO₃ precursor results in decreasing MoO₃ concentration along the gas flow direction. The coverage of films in the 4 irradiated areas from the one near the precursor to the one farthest is 73%, 50%, 28%, and 23%, respectively. The coverage on both growth and non-growth area of MoS₂ films follow the same decreasing trend. Interestingly, despite the overall decrease in film coverage, the selectivity has an increasing trend as the pattern gets farther from the precursor. FIG. 3H shows a plot of selectivity S as a function of distance from the molybdenum (Mo) precursor (in millimeters or mm) illustrating selectivity variation as a function of distance between the patterns and the Mo precursor according to various embodiments. The outlier at the 20 mm site may be due to the different rates of coverage decreasing in the irradiated area and in the non-irradiated area, as the coverage in irradiated area decreases but the coverage in non-irradiated area remains constant, compared to the pattern at the 17 mm site.

Further optimization shows that increasing irradiation time significantly enhances selectivity, reaching up to 0.7. FIG. 3I shows a plot of selectivity S as a function of the number of scan cycles on the irradiated area according to various embodiments. This result indicates that electron dosing may be a pivotal factor in tuning the preferential growth of MoS₂, offering insights into achieving high selectivity through tuning irradiation parameters. At a fixed region on the SiO₂ layer, the electron irradiation patterns were drawn on the site with different electron doses by varying the irradiation time within a 30×40 μm² rectangle. A view of the four patterns is shown in FIG. 3G. This optimization process may demonstrate tunability of selectivity in MoS₂ preferential growth assisted by electron dosing, and the results show higher selectivity compared to previous reports on charge-induced MoS₂ preferential growth. Table 1 compares the coverage and selectivity data related to electron dose induced selective growth of molybdenum disulfide (MoS₂) of the present work according to various embodiments and those of previous literature.

TABLE 1
Coverage and Selectivity of Electron
Dose Induced Selective Growth of MoS₂

| | θ_{I} | θ_{NI} | S |
|---|---|---|---|
| Previous literature 1 | 0.90 | 0.23 | 0.60 |
| Previous literature 2 | 1 | 0.22 | 0.64 |
| Present work | 0.62 | 0.01 | 0.97 |

The highest selectivity data is extracted from the images in each of the previous literature, with assistance of an open-source software (ImageJ). The present work as described herein may demonstrate the ability to achieve highly selective growth of MoS₂, a significant advancement as highlighted in Table 1. Through optimization of parameters such as growth temperature, pattern-precursor distance, and electron dose, the challenges posed by the result inconsistency of CVD growth yields may be addressed, ensuring high selectivity. The optimized conditions yield MoS₂ patterns with sharp, well-defined boundaries, as vividly illustrated in the AFM topography images. FIG. 3J shows (left) an atomic force microscopy (AFM) topography image of a pattern with high selectivity according to various embodiments; and (right) a magnified atomic force microscopy (AFM) topography image of the region in the left image as indicated by the dashed lines according to various embodiments. The size of the patterned area in the left image of FIG. 3J is 6×8 μm². Particularly notable is the dense nucleation within growth areas compared to the minimal nucleation in non-growth areas, underscoring the effectiveness of the optimization. A zoomed-in image collected from the lower edge region depicts dense nucleation of MoS₂ in the irradiated area, while nucleation in the non-irradiated area is extremely sparse. The optimized irradiation and CVD growth conditions are provided in the Methods section. Notably, the irradiation area size is reduced from 30×40 μm² to 6×8 μm², while maintaining the irradiation time, indicating the dose is equal to 25 times of the dose in a single scan of a 30×40 μm² area.

Raman intensity integration mapping of the E_{2g} peak is conducted to confirm the overall pattern quality and selectivity in this area. FIG. 3K shows a Raman molybdenum disulfide (MoS₂) E_{2g} peak intensity mapping of the patterned area as shown in the left image of FIG. 3J according to various embodiments. With a selectivity of 0.97 in FIG. 3J (θ₁=0.62; θ_{NI}=0.01), the method as described herein may set a benchmark for preferential MoS₂ growth. This exceptional selectivity, detailed in Table 1 as “Present Work”, may underscore the efficacy of surface charging by electron beam irradiation in guiding precise TMD growth.

The capability for a sub-μm spatial resolution in growth patterns may also be revealed, and resolutions as fine as ~100 nm may be achieved. This precision is showcased in the right image in FIG. 3J (an irradiation area as large as 6×8 μm² under a 5 keV electron beam) indicates that the resolution was limited by flake size, offering new avenues for nano-scale patterning of TMDs. The MoS₂ film in this 6×8 μm² irradiation area is in form of flakes. The zoom-in SEM image shows a line-by-line flake deposition during CVD growth on this 6×8 μm² pattern. FIG. 3L shows a scanning electron microscopy (SEM) image of a 20×20 μm² 5 keV irradiated area (lower left corner) after growth according to various embodiments. From FIG. 3L, the highest spatial resolution achieved in the growth is ~100 nm, which is comparable to the size of the flakes in the patterned area. A prior literature has demonstrated that electron beam irradiation can realize exceptional line-by-line scan precision. In the present work, line-by-line scanning feature, followed by CVD growth, is realized. Given the size of nanoflakes observed around the pattern, this method may have an immense potential to be applied to precise nano-writing of TMD flake growth.

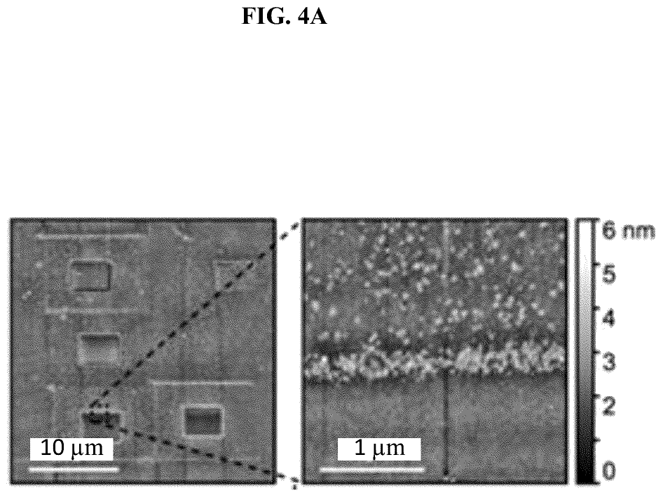

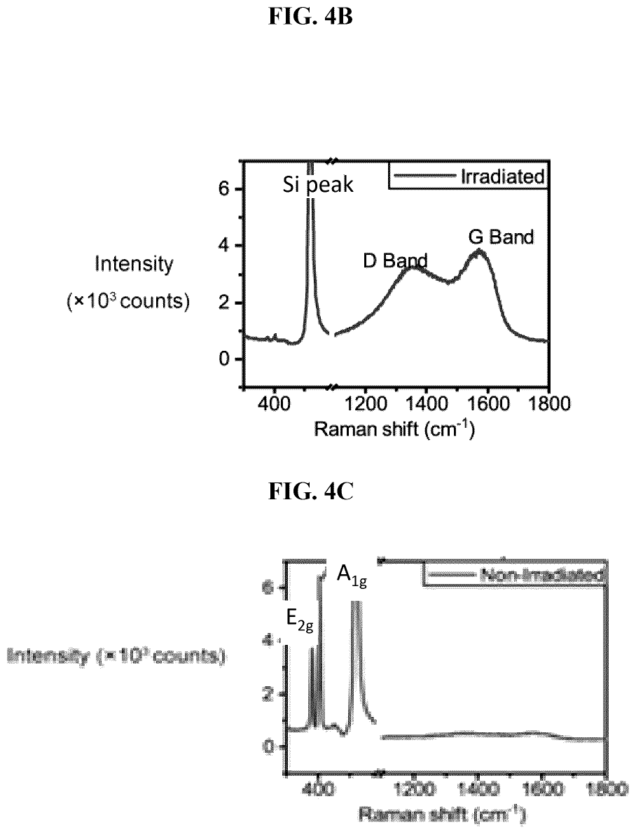

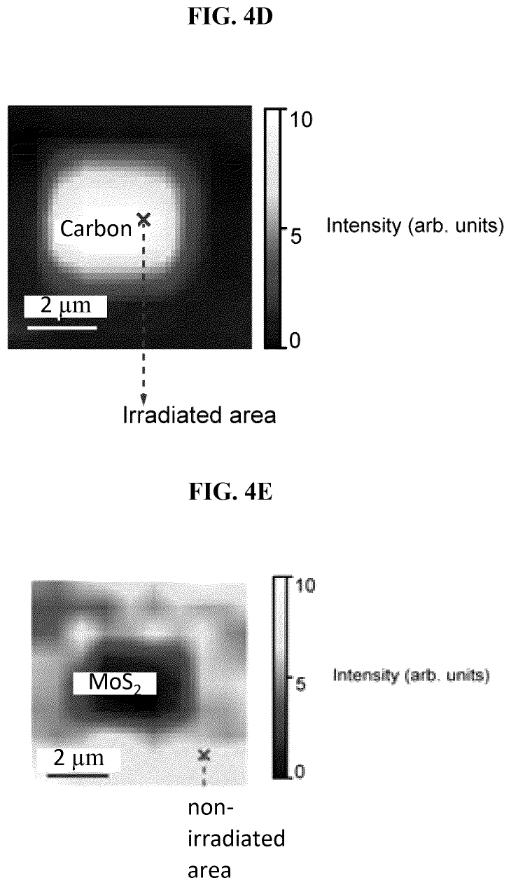

Amorphous carbon adsorption on electron irradiated surface may also be observed. The amorphous carbon presence during CVD could alter the growth behavior. The amorphous carbon adsorption induced by high-dose electron irradiation is observed to lead to negative selectivity after CVD, leading to sparse growth within irradiated areas, in contrast to dense growth in the surrounding non-irradiated area. FIG. 4A shows (left) an atomic force microscopy (AFM) topography image of the negatively patterned area of 3×4 μm² according to various embodiments; and (right) a magnified topography image of the edge region indicated by the black box in the left image according to various embodiments. By reducing the pattern size to 3×4 μm² and varying the number of scan cycles (1 cycle=162 s) from 1 to 4, the electron dose is significantly increased, achieving more than 100 times the dose used in previous 30×40 μm² experiments. This adjustment resulted in distinct negative growth patterns, as shown in the sharply defined AFM topography images.

A pivotal finding from the present study is the identification of amorphous carbon deposition as a critical factor in this negative selectivity, Raman spectrum. FIG. 4B shows a plot of intensity (×10³ counts) as a function of Raman shift (per centimeter or cm⁻¹) illustrating the Raman spectrum extracted from the high dose irradiated area according to various embodiments, indicating carbon deposition. FIG. 4C shows a plot of intensity (×10³ counts) as a function of Raman shift (per centimeter or cm⁻¹) illustrating the Raman spectrum extracted from the non-irradiated area according to various embodiments, indicating molybdenum disulfide (MoS₂) deposition. Raman spectrum as shown in FIG. 4B after irradiation and CVD growth exhibits a pronounced presence of amorphous carbon deposition in the irradiated area, which is marked as D and G band broad peaks in the spectrum, with MoS₂ peaks markedly diminished, which indicates sparse nucleation in this irradiated area—a stark contrast to the strong MoS₂ peaks observed in FIG. 4C, in which the amorphous carbon peaks are nearly invisible.

Raman peak intensity integration mappings of the carbon broad peaks and MoS₂ E_{2g} peak around the patterning area further confirm that the irradiated area shows only significant amorphous carbon deposition, with coexistence of MoS₂ in the non-irradiated area surrounding the irradiated area. FIG. 4D shows a Raman peak intensity mapping of carbon D and G bands after high-dose irradiation and chemical vapor deposition (CVD) growth around the region marked in FIG. 4A. according to various embodiments. FIG. 4E shows a Raman peak intensity mapping of molybdenum disulfide (MoS₂) E_{2g} peak around the same region as indicated in FIG. 4D according to various embodiments. The contrasting coverages of carbon and MoS₂ shown in FIGS. 4D-E, respectively, may indicate absence of dense MoS₂ nucleation in the irradiated 3×4 μm² area, but abundant carbon deposition in the irradiated area. In comparison, the surrounding non-irradiated area is covered by dense MoS₂ nucleation, but with relatively little carbon adsorption. This distinct contrast may indicate that during electron irradiation, amorphous carbon was deposited on the surface of the SiO₂ layer. The deposition of amorphous carbon, from chamber contaminants, may act as an effective barrier to MoS₂ nucleation, demonstrating that electron irradiation can induce negative selectivity in MoS₂ growth on SiO₂.

A previous study had similarly observed growth inhibition on electron-irradiated graphene, and a hypothesis was made based on charging on the irradiated graphene, which is still elusive. The characterization of MoS₂ growth on SiO₂ as described herein may further elucidate the critical role of amorphous carbon in MoS₂ growth inhibition, advancing the understanding of selective growth process. These 3×4 μm² patterns were extracted from a set of patterns in a large patterning area on the same SiO₂/Si wafer. Therefore, this pattern cluster experienced the same conditions during irradiation, storage, CVD growth, and characterization. FIG. 5A shows an optical microscopy image of the whole patterning area, including the 3×4 μm² patterns according to various embodiments. FIG. 5A highlights that the variation in selectivity is tuned by the irradiation conditions alone. These distinctive patterns of growth and non-growth areas underscore the dual role of electron irradiation in modulating surface conditions. The deposition of amorphous carbon may act as an effective barrier to MoS₂ nucleation, offering a mechanics of long-duration irradiation induced negative selective growth.

Understanding the surface modification process during the electron beam irradiation is critical to the investigation of the driving force of the preferential growth, and proposing a reliable optimization strategy for this bottom-up patterning approach. In general, three key effects induced by electron irradiation may be observed: (i) carbon contaminants deposition; (ii) surface etching; and (iii) surface potential difference, each playing distinct roles in modulating growth.

### Carbon Contaminants Deposition

Carbon deposition is revealed to primarily contribute to negative selectivity by acting as a growth inhibitor. This insight, derived from both previous experiments and the following investigation in the cryotrap-equipped SEM, highlights the nuanced impact of carbon contaminants. A model of SEM (3D Versa, FEI), with a cryotrap attached to the microscope vacuum chamber, may be chosen. The cryotrap attachment contains liquid nitrogen to lower temperature inside the chamber to preferentially adsorb contaminants in the vacuum, and then to reduce the amorphous carbon deposition on the SiO₂/Si substrate surface. Notably, the Versa SEM is equipped with a patterning tool that enables direct pattern drawing and dose control of the electron beam.

FIG. 5B shows a schematic illustrating the pattern size and pitch of an array in which the same dose of 1 nC/μm² is applied to each pattern according to various embodiments. FIG. 5C shows a plot of intensity (10× counts) as a function of Raman shift (per centimeter or cm⁻¹) illustrating the Raman spectra of chemical vapor deposition (CVD) preferential growth areas after irradiation in these areas in the Versa scanning electron microscopy (SEM) according to various embodiments. The range of the Raman shift axis covers the region of the D and G band peaks of amorphous carbon (~1200-1700 cm⁻¹). The absence of the peaks indicates the deposition of amorphous carbon is reduced and undetectable in contrast to high-intensity MoS₂ peaks. Positive selective growth of MoS₂ may be present with the absence of amorphous carbon deposition within the irradiated areas. FIG. 5D shows a Kelvin probe force microscopy (KPFM) mapping of the array according to various embodiments. FIG. 5E shows an optical microscopy image of the array according to various embodiments. Thus, it may be concluded that amorphous carbon (as discussed previously) is not the driving force of MoS₂ preferential growth but rather serves as a blocking layer to MoS₂ growth. FIG. 5F shows atomic force microscopy (AFM) topography images of each pattern from A to D as shown in FIG. 5B according to various embodiments. Thus, it may be concluded that amorphous carbon (as discussed previously) may not be the driving force of MoS₂ preferential growth but may rather serve as a blocking layer to MoS₂ growth.

### Surface Etching

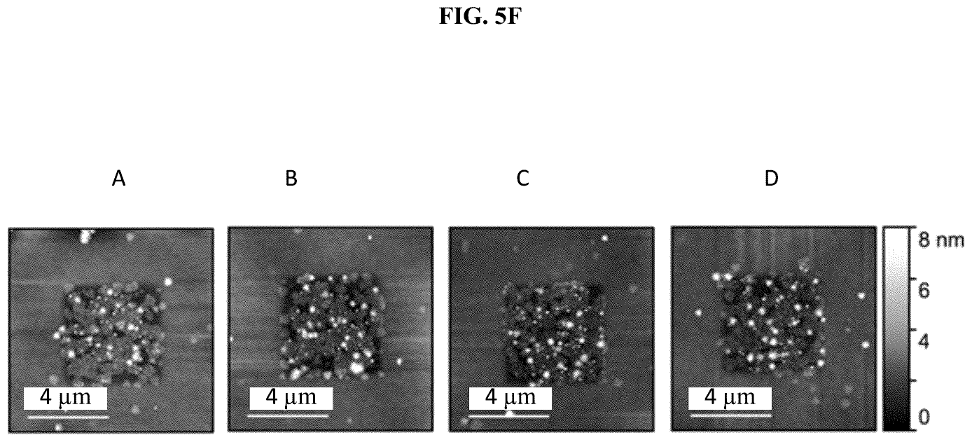

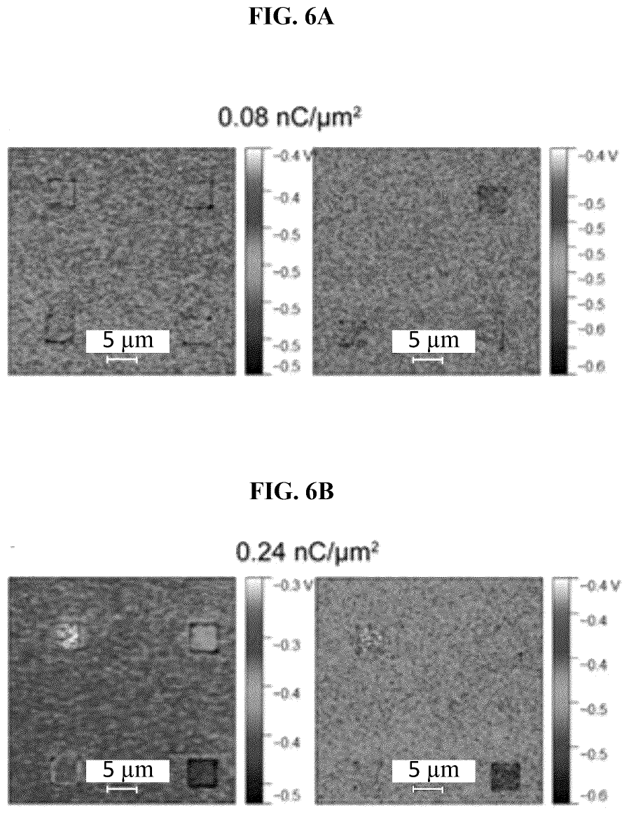

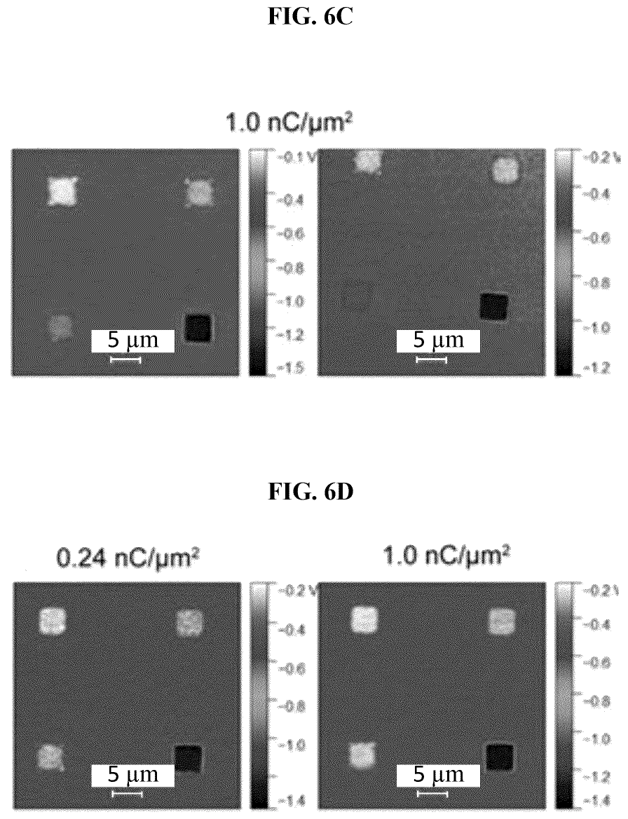

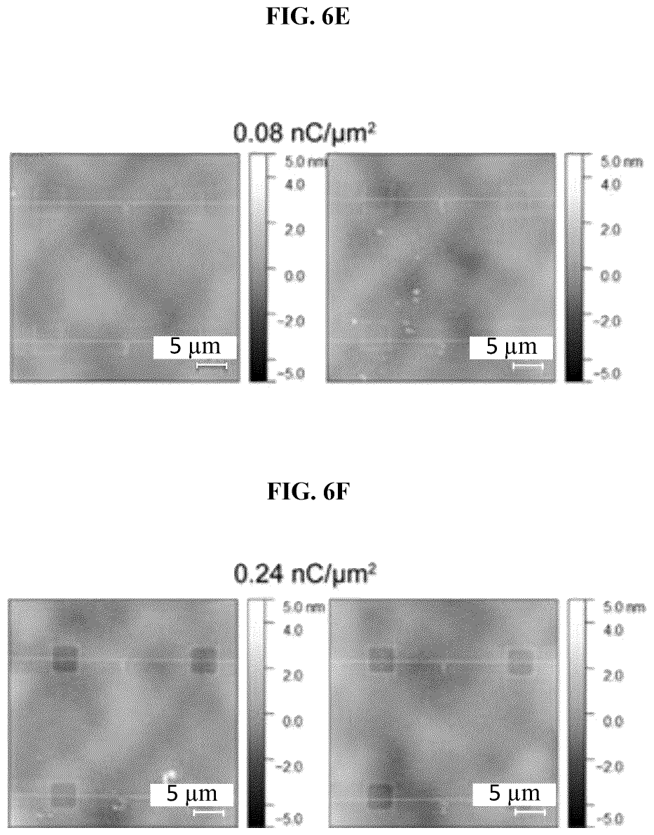

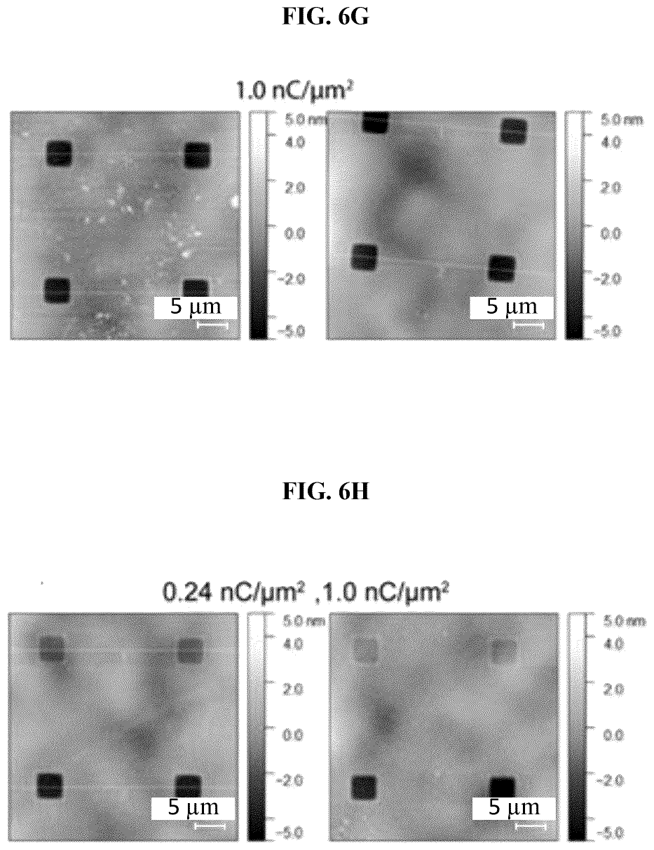

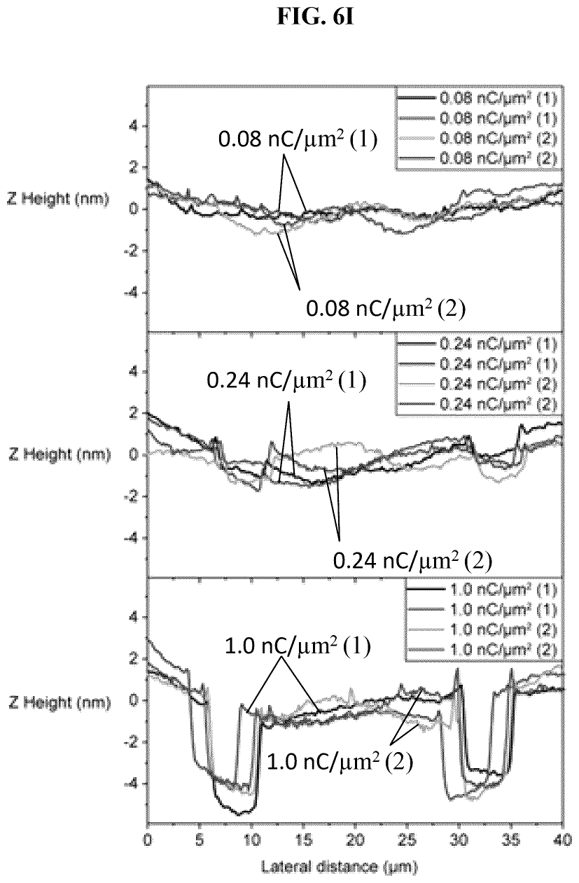

FIG. 6A shows a Kelvin probe force microscopy (KPFM) mapping of the array after being irradiated with a dose of 0.08 nC/μm² according to various embodiments. FIG. 6B shows a Kelvin probe force microscopy (KPFM) mapping of the array after being irradiated with a dose of 0.24 nC/μm² according to various embodiments. FIG. 6C shows a Kelvin probe force microscopy (KPFM) mapping of the array after being irradiated with a dose of 1.0 nC/μm² according to various embodiments. FIG. 6D shows a Kelvin probe force microscopy (KPFM) mapping of the array in which the top two patterns are irradiated with a dose of 0.24 nC/μm² and the bottom two patterns are irradiated with a dose of 1.0 nC/μm² according to various embodiments.

FIG. 6E shows an atomic force microscopy (AFM) topography image of the array after being irradiated with a dose of 0.08 nC/μm² according to various embodiments. FIG. 6F shows an atomic force microscopy (AFM) topography image of the array after being irradiated with a dose of 0.24 nC/μm² according to various embodiments. FIG. 6G shows an atomic force microscopy (AFM) topography image of the array after being irradiated with a dose of 1.0 nC/μm² according to various embodiments. FIG. 6H shows an atomic force microscopy (AFM) topography image of the array in which the top two patterns are irradiated with a dose of 0.24 nC/μm² and the bottom two patterns are irradiated with a dose of 1.0 nC/μm² according to various embodiments.

The surface etch-down as shown in FIGS. 6A-H may be prominent after 5 keV irradiation with specific dose. The pattern follows that shown in FIG. 5B. FIGS. 6A-D show Kelvin-probe force microscopy (KPFM) surface potential maps of 8 irradiation pattern arrays. Each array includes 4 of 5×5 μm² square patterns, and the pattern pitch of each array is 25 μm. Due to the narrow pitch of the patterns in the same array, there may be strong interference amongst the charged areas. As such, patterns with the same dose may show completely different surface potential values. However, the trends of the variation of potential value in each array may be identical or closely similar, indicating that the interactions among charged areas undergo the same process. The charging process of the close-pitch patterns at the same dose but delivering different surface potentials may need to be further clarified.

Despite the different surface potential values, areas irrigated with the same dose may show similar CVD growth results: areas irradiated with doses of 0.08 nC/μm² and 0.24 nC/μm² are free from MoS₂ preferential nucleation; and areas with 1.0 nC/μm² dose are covered with dense MoS₂ flakes, which is depicted in the optical microscope image as shown in FIG. 5E and the AFM images as shown in FIG. 5F. The AFM topography etching depths of as-irradiated samples are plotted in FIGS. 6I-J, which may demonstrate that the heavily dosed areas are etched down more than the lightly dosed ones. FIG. 6I shows plots of height along the Z-axis (in nanometers or nm) as a function of lateral distances (in micrometers or μm) illustrating the line profiles of irradiated pattern areas extracted respectively from atomic force microscopy (AFM) images as shown in FIGS. 6E-G according to various embodiments. (1) represents the line profiles (i.e., line profiles across top row and bottom row of patterns) extracted across the first array, while (2) represents the line profiles (i.e., line profiles across top row and bottom row of patterns) extracted across the second array as shown in FIGS. 6E-G. FIG. 6J shows a plot of average height (in nanometers or nm) as a function of position illustrating depths of the patterns in positions A-D as shown in FIGS. 6E-H according to various embodiments.

In addition, it has been observed in the right image of FIG. 4A that MoS₂ is more likely to nucleate at the edge step. The etching feature characterized by AFM, as a driving force for nucleation, may exhibit a strong correlation with the preferential nucleation of MoS₂ in these areas irradiated by the 5 keV electron beam.

### Surface Potential Difference

The variation in surface potential, particularly pronounced at 30 keV, may underscore its critical role in guiding preferential growth. It is found that there may be a strong correlation between surface potential and MoS₂ nucleation. Besides the 5 keV irradiation on SiO₂/Si substrates, electron beam irradiation at other levels of beam energy has also been explored.

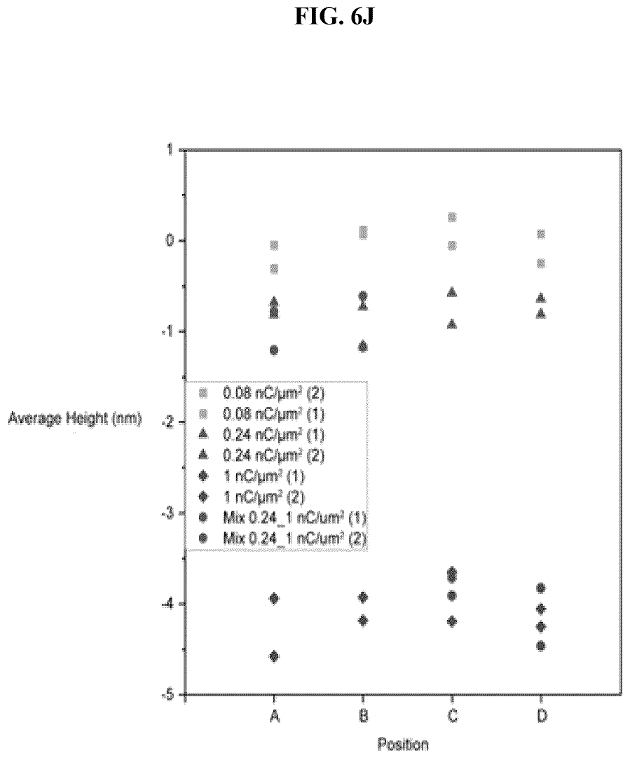

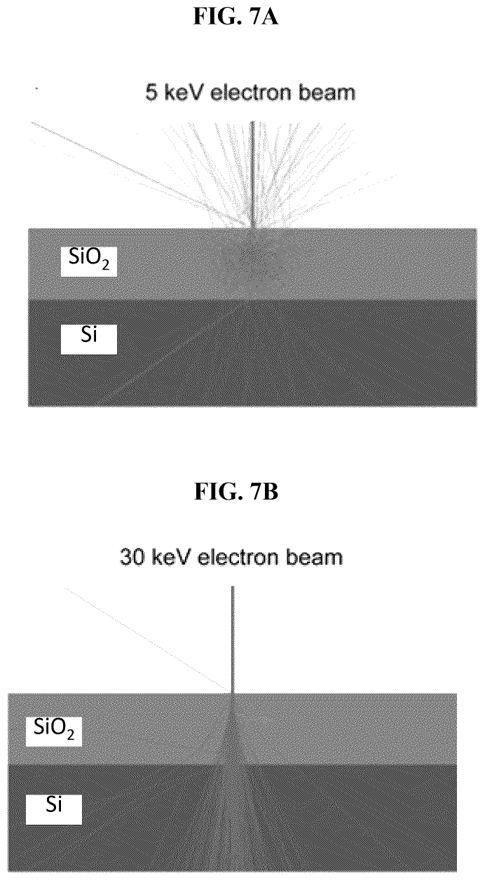

FIG. 7A is a schematic illustrating a Monte Carlo stimulation on the trajectory of electrons of a 5 keV electron beam on a 300 nm thick silicon oxide (SiO₂) layer according to various embodiments. FIG. 7B is a schematic illustrating a Monte Carlo stimulation on the trajectory of electrons of a 30 keV electron beam on a 300 nm thick silicon oxide (SiO₂) layer according to various embodiments. Considering the different interaction shapes and volumes of incident electrons within the oxide layer revealed by the Monte Carlo simulations shown in FIGS. 7A-B, it may be expected that there would be more trapped electrons inside the oxide layer when a 5 keV beam is used, compared to a 30 keV beam. The trapped electrons may interact with the consequent incoming electron beam, causing surface damage to the silicon oxide (SiO₂) layer. A previous quantitative analysis of surface damage on SiO₂/Si specimen caused by electron beam irradiation demonstrated that a critical electron dose for damaging the SiO₂ surface exists at a certain electron incident energy. The critical electron dose may increase with increasing incident beam energy on a logarithmic scale. Therefore, less surface damage may be expected as the beam energy is increased to 30 keV while maintaining the dose level.

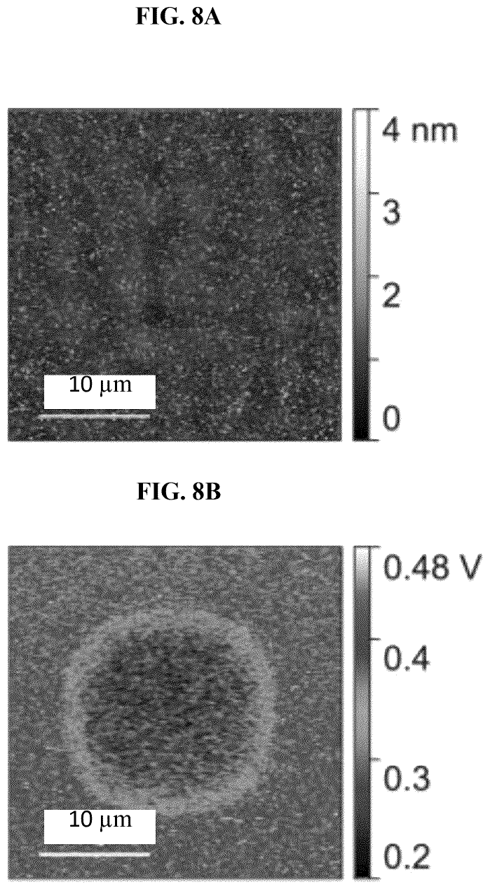

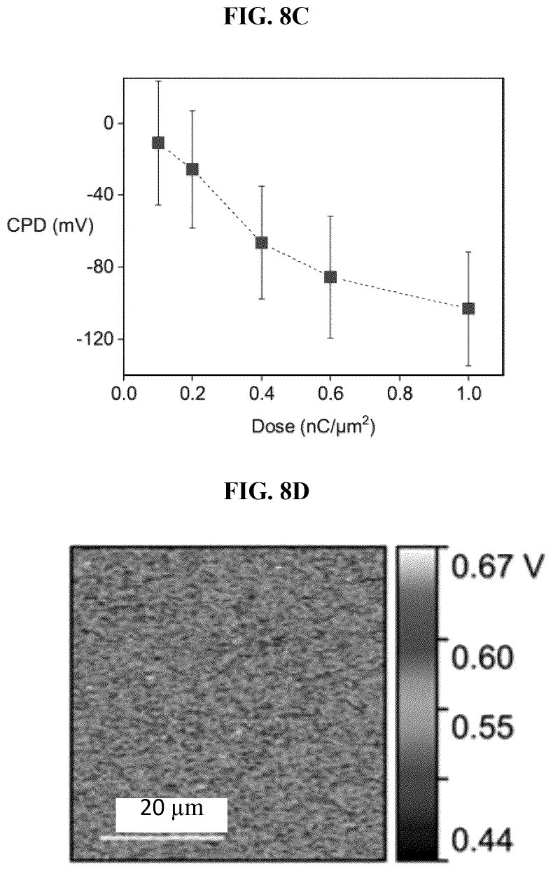

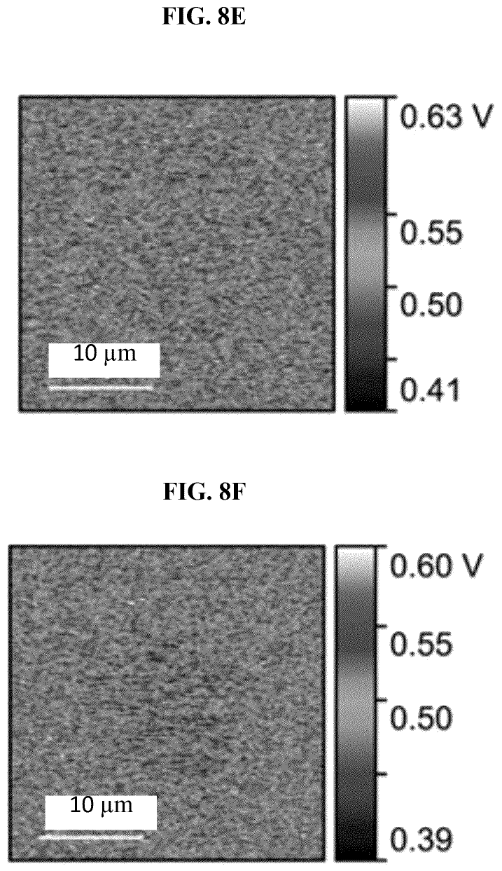

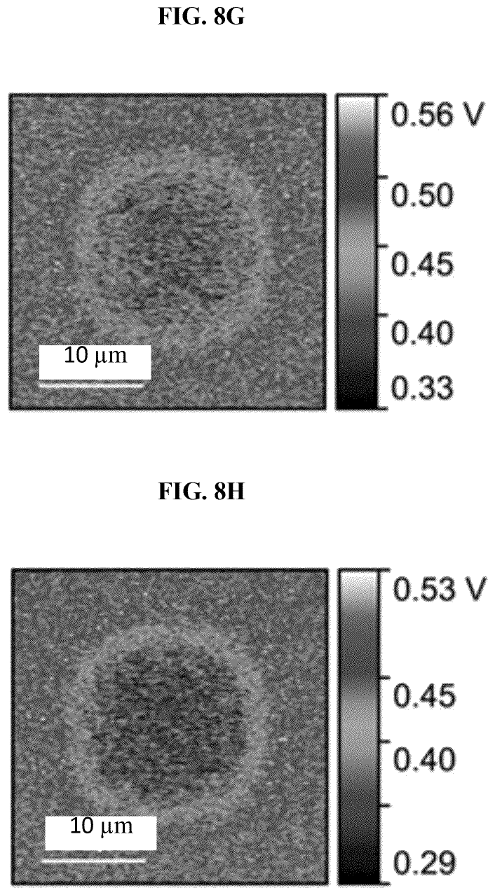

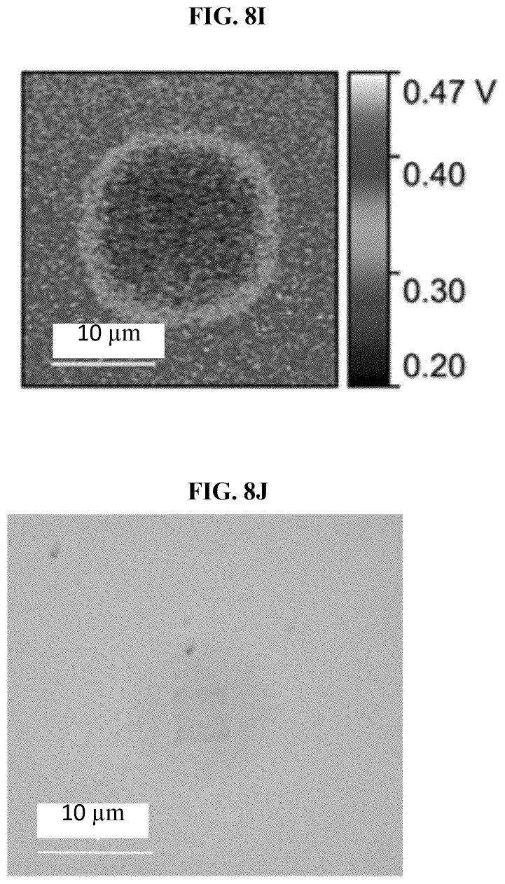

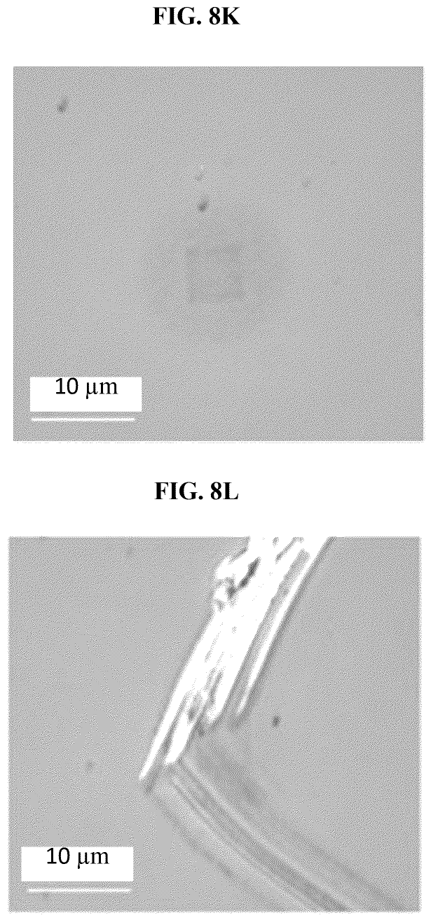

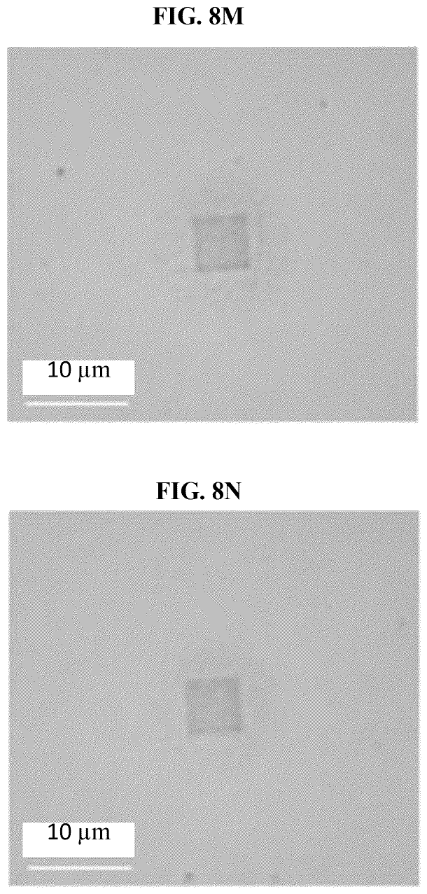

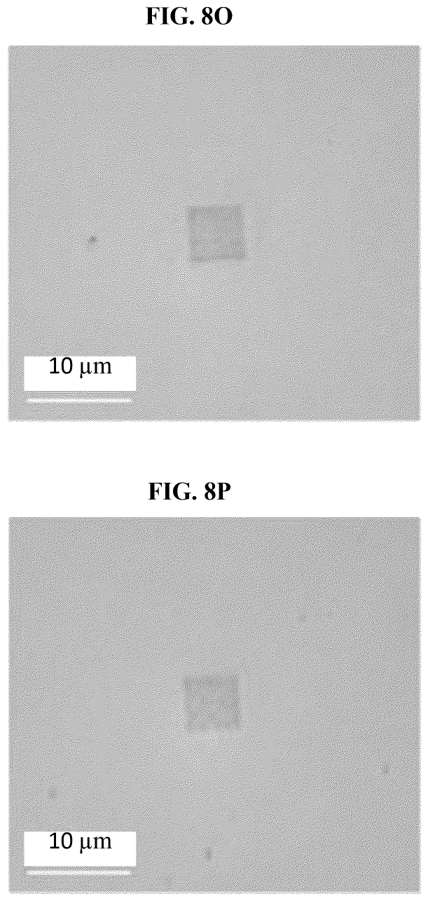

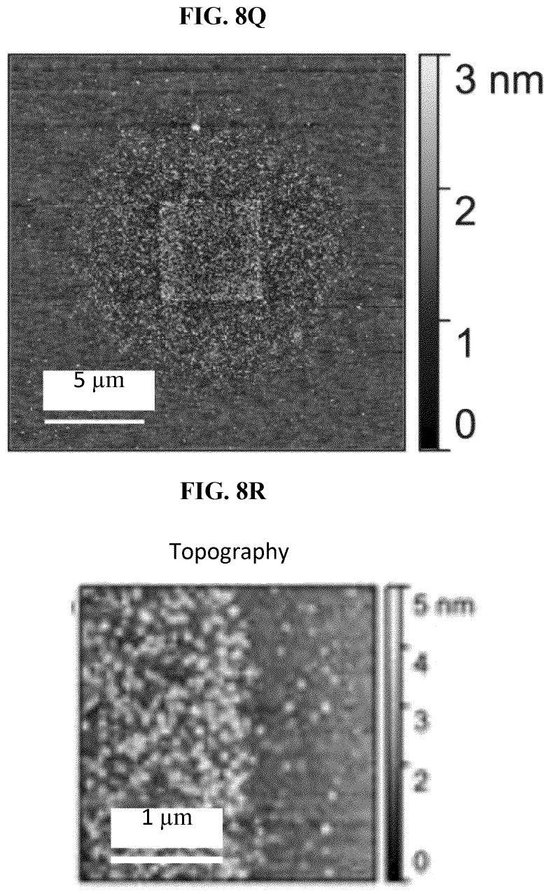

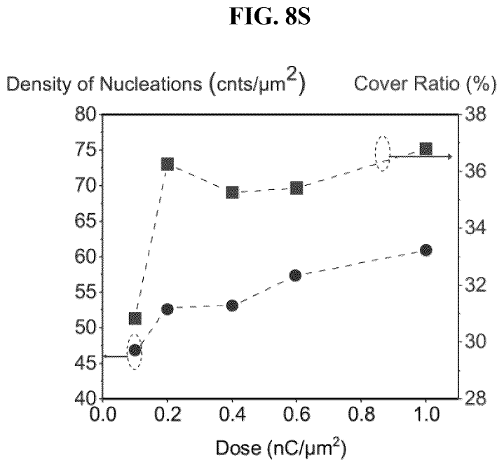

FIG. 8A shows an atomic force microscopy (AFM) topography image of an as-irradiated silicon oxide (SiO₂) surface after a dose of 1 nC/μm² according to various embodiments. FIG. 8B shows a Kelvin probe force microscopy (KPFM) surface potential mapping image of the as-irradiated silicon oxide (SiO₂) surface as shown in FIG. 8A after the dose of 1 nC/μm² according to various embodiments. As shown in FIG. 8A, at 30 keV, the SiO₂ surface may be etching-free (i.e., with no apparent etched features) after irradiation. Meanwhile, the KPFM surface potential mapping image (as shown in FIG. 8B) shows prominent contrast in terms of surface potential value, indicating a negatively charged surface in irradiated regions. Notably, the edge region around the irradiated area is not sharp, due to the defocus of the electron beam at 30 keV voltage.

In this set of experiments (i.e., involving 30 keV irradiation), topography features remain flat and show no patterning shape at all, which indicate that the surface etched features (which serve as a driving force for growth on the sample under 5 keV irradiation) may be absent and may not serve any role in relation to the sample under 30 keV irradiation. The difference in contact potential difference between irradiated and pristine region (i.e., contact potential difference, CPD) as a function of electron dose is plotted in FIG. 8C, and the surface potential mapping images are provided in FIGS. 8D-I. FIG. 8C shows a plot of contact potential difference CPD (in millivolts or mV) as a function of dose (in nano-Coulomb per square micrometer or nC/μm²) illustrating the variation of CPD with dose according to various embodiments. FIG. 8D shows a Kelvin probe force microscopy (KPFM) surface potential mapping image of the irradiated area after 30 keV irradiation using a dose of 0.1 nC/μm² according to various embodiments. FIG. 8E shows a Kelvin probe force microscopy (KPFM) surface potential mapping image of the irradiated area after 30 keV irradiation using a dose of 0.2 nC/μm² according to various embodiments. FIG. 8F shows a Kelvin probe force microscopy (KPFM) surface potential mapping image of the irradiated area after 30 keV irradiation using a dose of 0.4 nC/μm² according to various embodiments. FIG. 8G shows a Kelvin probe force microscopy (KPFM) surface potential mapping image of the irradiated area after 30 keV irradiation using a dose of 0.6 nC/μm² according to various embodiments. FIG. 8H shows a Kelvin probe force microscopy (KPFM) surface potential mapping image of the irradiated area after 30 keV irradiation using a dose of 0.8 nC/μm² according to various embodiments. FIG. 8I shows a Kelvin probe force microscopy (KPFM) surface potential mapping image of the irradiated area after 30 keV irradiation using a dose of 1.0 nC/μm² according to various embodiments.

CVD growth was conducted on another SiO₂/Si substrate after irradiation with the same dose conditions. FIG. 8J shows an optical microscopy image of the as-grown molybdenum disulfide (MoS₂) pattern according to various embodiments. The optical image in FIG. 8J shows two distinct growth regions in each patterned area: a square region matching the 5×5 μm² dimension, and a defocused region formed due to the defocusing of the electron beam. Optical images of the patterns irradiated with different doses are provided in FIGS. 8K-P. FIG. 8K shows an optical image of the irradiated area after 30 keV irradiation using a dose of 1.0 nC/μm² according to various embodiments. FIG. 8L shows an optical image of the irradiated area after 30 keV irradiation using a dose of 0.8 nC/μm² according to various embodiments. The pattern is over a scratch on the substrate. FIG. 8M shows an optical image of the irradiated area after 30 keV irradiation using a dose of 0.6 nC/μm² according to various embodiments. FIG. 8N shows an optical image of the irradiated area after 30 keV irradiation using a dose of 0.4 nC/μm² according to various embodiments. FIG. 8O shows an optical image of the irradiated area after 30 keV irradiation using a dose of 0.2 nC/μm² according to various embodiments. FIG. 8P shows an optical image of the irradiated area after 30 keV irradiation using a dose of 0.1 nC/μm² according to various embodiments.

The magnetic lens system is not well calibrated for high energy electron beam in relation to this SEM. Therefore, the electron beam is not well focused such that the distribution of electrons reaching the surface is widened beyond the focused area, and the surrounding area of the pattern is consequently irradiated. The subsequent CVD growth is in line with the distribution of electrons reaching the surface, and shows two distinct growth regions. The irradiated area here on this sample refers to the focused area. FIG. 8Q shows an atomic force microscopy (AFM) topography image of as-grown molybdenum disulfide (MoS₂) on silicon oxide (SiO₂) surfaces according to various embodiments. The MoS₂ is grown after irradiation with a dose of 1 nC/μm². FIG. 8R shows a zoomed-in image of the right edge of the irradiated area in FIG. 8Q according to various embodiments.

From the AFM topography images (which includes FIGS. 8Q-R), the nucleation and flake coverage as functions of electron dose within irradiated areas was plotted. FIG. 8S shows a plot of density of nucleations (counts/square micrometer or cnts/μm²)/cover ratio (in percent or %) as a function of dose (in nano-Coulomb per square micrometer or nC/μm²) illustrating the variation of coverage and nucleation with does according to various embodiments. FIG. 8S shows that there may be a strong correlation between surface potential and nucleation rate on irradiated areas, given that the surface morphology is not modified on as-irradiated samples. Notably, there may be an explicit correlation of nucleation and growth with CPD in irradiated areas: a more negative CPD may lead to higher nucleation and coverage of MoS₂. The irradiation at 30 keV and the consequent growth show that the positive selective growth may be driven by the negative surface potential under the 30 keV electron beam. By ruling out the impact of topography damage and surface carbon, selective growth of the 2D material may be found to be mediated by the surface potential induced by electron irradiation.

### Si—O—Si Bond Modification

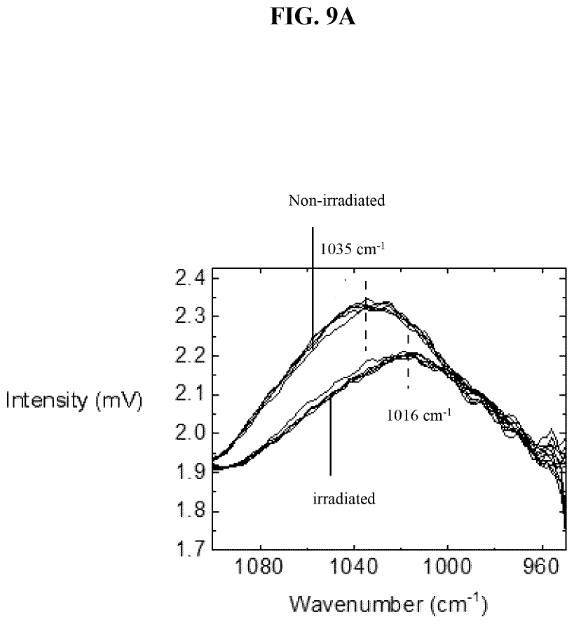

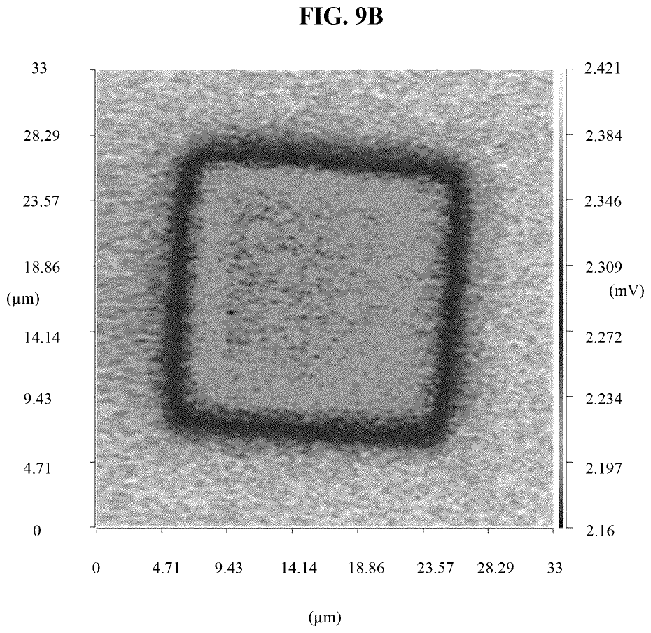

Fourier Transform Infrared (FTIR) spectroscopy was conducted using a mIRage sub-micron infrared (IR) spectroscopy equipment from Photothermal Spectroscopy Corp. The FTIR spectroscopy was used to reveal the modification of Si—O—Si bond angle. In amorphous SiO₂, the SiO₄ tetrahedra network contains ring structures with different configurations. While the most common ring in amorphous SiO₂ is n=6, the planar rings formed by SiO₄ tetrahedra can alternatively be of order n 6, where n is the number of Si atoms in a ring. Once an n ordered ring is formed, the ring may attempt to minimize the energy by changing the Si—O—Si bond angle to relax the ring structure. FTIR can measure the Si—O—Si bond angle change by observing the relative shift of infrared (IR) transverse optical (TO) response in the absorption spectrum. Asymmetrical TO bands are within the range of 1100-1000 cm⁻¹. FIG. 9A shows a plot in intensity (in millivolts or mV) as a function of wavenumber (per centimeter or cm⁻¹) illustrating the asymmetrical traverse optical (TO) bands of non-irradiated and irradiated amorphous silicon oxide (SiO₂) surface according to various embodiments. The irradiation dose is 500 pC/μm² with 5 keV e-beam energy. The irradiation area is 20×20 μm². The TO peak positions of non-irradiated and irradiated SiO₂ are 1035 cm⁻¹, and 1016 cm⁻¹, respectively. According to the relationship between the bond angle change and the band shift:

ω=α[2(α sin²θ/2+βcos²θ/2)/m]² (2)

α and β are the central and noncentral force constants, m is the mass of the oxygen atoms, and θ is the bridging bond angle of Si—O—Si. If m is in kg, and a is in N*m⁻¹, then the multiplying constant 5.305*10⁻¹² yields ω in cm⁻¹. A compilation of data on materials where θ has been measured directly by some methods such as electron or x-ray diffraction shows α=582 N*cm⁻¹ and β=264 N*cm⁻¹ for θ<150° as a very good approximation.
The bond angle of the non-irradiated area may be greater than the bond angle of the irradiated area, e.g., by 7.5°. FIG. 9B shows an intensity mapping illustrating the spatial contrast between the irradiated area and the non-irradiated area at 1035 cm⁻¹ according to various embodiments. For avoidance of doubt, FIGS. 9A-B pertain to FTIR spectra/mapping of SiO₂ peaks.

The above results may mark a significant advancement in the selective growth of TMD on SiO₂/Si surfaces, utilizing electron beam irradiation to achieve unparalleled selectivity and precision. A remarkable positive selectivity of up to 0.97 has been demonstrated, attributable to optimized irradiation conditions. Conversely, there may be conditions under which electron irradiation leads to negative selectivity, i.e., with amorphous carbon deposition acting as a growth inhibitor. Sub-μm resolution MoS₂ growth has also been shown, and pattern pitches as fine as 100 nm have been achieved. This level of precision may open promising prospects associated with electron irradiation on SiO₂ surface to be applied to nano-writing of TMDs. The driving force of selective growth after electron beam irradiation has also been investigated by multiple tools. Selective growth may be driven by surface degradation, and surface potential due to charge accumulation in the SiO₂ layer (synergically at 5 keV). At 30 keV, the growth selectivity hinges on the surface charge in SiO₂, with the absence of surface etching on SiO₂ surface. SiO₂/Si substrate is a widely used substrate for TMDs growth, and electron irradiation may be versatile in patterning surface charge with distinguished precision and diverse geometry. This approach may provide a promising pathway to achieving nano-patterning in a bottom-up fashion, circumventing the complexities of traditional lithography. Various embodiments may not only potentially streamline the fabrication of 2D electronic devices, but may also open new avenues for research into the controlled synthesis of TMDs for various applications.

Various embodiments may enable a lithography-free process. The patterning process of 2D materials may be simplified by direct growth of the 2D patterns. The lithography-free process may address the complexity and high cost of the existing photolithography process, and reduce surface contaminations that degrade the quality of 2D materials. Various embodiments may relate to a growth process promoted by surface charge. Accordingly, surface chemical modification that may affect the interface quality between 2D materials and substrates may be avoided. Also, various embodiments may allow uniform growth of 2D materials without any pre-deposited seeds. Various embodiments may relate to electron implantation on insulating layer by electron beam irradiation, which may enable creation or editing of complex and random shape patterning with high precision. Various embodiments may reduce CVD deposition growth temperature of 2D materials to BEOL-compatible levels, which may enable direct fabrication of patterns on devices that are unable to withstand high temperature, including flexible substrates. Various embodiments may relate to the direct electron beam irradiation on SiO₂, followed by CVD MoS₂ growth, which may be a less complex method to grow MoS₂ micro/nano-patterns on dielectric layers. Various embodiments may not require use of chemical inhibitors (like self assembled monolayers) for the selective growth, which may reduce manufacturing complexity and enhance scalability for industrial applications.

1. A method of forming a two-dimensional material, the method comprising:
introducing charges to a dielectric layer or substrate such that a bond angle between adjoining bonds of atoms comprised in the dielectric layer or substrate is changed; and
providing one or more precursors to form the two-dimensional material on the dielectric layer or substrate.

2. The method according to claim 1,
wherein the change in the bond angle leads to preferential growth of the two-dimensional material.

3. The method according to claim 1,
wherein the change in the bond angle leads to a change in a number of free bonds present in the dielectric layer or substrate.

4. The method according to claim 1,
wherein the charges are introduced to the dielectric layer or substrate using an irradiation process.

5. The method according to claim 4,
wherein the irradiation process is electron beam irradiation, ion beam irradiation or laser beam irradiation.

6. The method according to claim 5,
wherein the irradiation process is electron beam irradiation or ion beam irradiation; and
wherein an energy of the irradiation process below a predetermined threshold creates etched features on the dielectric layer or substrate.

7. The method according to claim 6,
wherein edge steps of the etched features show preferential growth of the two-dimensional material.

8. The method according to claim 6,
wherein the energy of the irradiation process equal to or exceeding the predetermined threshold does not create etched features on the dielectric layer or substrate.

9. The method according to claim 1,
wherein growth of the two-dimensional material on the dielectric layer or substrate increases with a number of charges trapped in the dielectric layer or substrate.

10. The method according to claim 1,
wherein the dielectric layer or substrate comprises silicon oxide (SiO₂), hydrogenated silicon-carbon (SiCH), fluorinated silicon oxide (SiOF), aluminum oxide (Al₂O₃), hafnium oxide (HfO₂) or zirconium oxide (ZrO₂).

11. The method according to claim 1,
wherein the two-dimensional material is a transition metal dichalcogenide material.

12. The method according to claim 11,
wherein the transition metal dichalcogenide material is molybdenum disulfide (MoS₂).

13. The method according to claim 12,
wherein molybdenum oxide (MoO₃) is positioned at a predetermined distance from the dielectric layer or substrate; and
wherein sulfur is carried by an inert gas to react with molybdenum oxide (MoO₃) to form molybdenum disulfide (MoS₂) on the dielectric layer or substrate.

14. The method according to claim 13,
wherein the predetermined distance is at least 20 mm.

15. The method according to claim 12,
wherein molybdenum disulfide (MoS₂) is grown using chemical vapor deposition (CVD).

16. The method according to claim 12,
wherein molybdenum disulfide (MoS₂) is grown using a temperature selected from a range from 400° C. to 650° C.

17. The method according to claim 1,
wherein selectivity increases with a number of scan cycles.

18. The method according to claim 1, further comprising:
forming an amorphous carbon layer on the dielectric layer or substrate, the amorphous carbon layer formed due to contaminants.

19. The method according to claim 18,
wherein the amorphous carbon layer serves as a blocking layer.

20. The method according to claim 18,
wherein growth of the two-dimensional material on the amorphous carbon layer is prevented or reduced.
